(19) United States
(12) Patent Application Publication
(10) Pub. No.: US 2013/0179777 A1
(43) Pub. Date: Jul. 11, 2013

(54) METHOD OF REDUCING COMPUTING TIME AND APPARATUS THEREOF

(71) Applicants: Francois Cassistat, Montreal (CA); Mathieu Audet, Montreal (CA)

(72) Inventors: Francois Cassistat, Montreal (CA); Mathieu Audet, Montreal (CA)

(21) Appl. No.: 13/737,553

(22) Filed: Jan. 9, 2013

Related U.S. Application Data
(60) Provisional application No. 61/585,000, filed on Jan. 10, 2012.

(51) Int. Cl. G06F 17/21

(52) U.S. Cl. CPC G06F 17/212
USPC 715/243

(57) ABSTRACT

A method, a system and an interface adapted to enhance the computing power of computer systems, the method being designed to calculate the position of documents as they are displayed on computer screens. The documents are displayed on axes belonging to axes group(s). The method relates to reducing and/or minimizing the computing power necessary to identify the position of documents when they are subject to displacement caused by the movement of the axes groups to which they belong and/or of the display screen.

### CROSS REFERENCE TO RELATED APPLICATIONS

The present application is a non-provisional of, and claims priority under 35 U.S.C. 119(e) to, U.S. provisional application No. 61/585,000, entitled AUTOMATIC ATTRIBUTE ASSOCIATION AND COMPUTING TIME REDUCTION, filed on Jan. 10, 2012, which is herein incorporated by reference in its entirety. Any publication of and any patent issuing from the foregoing U.S. patent applications are hereby incorporated herein by reference.

### FIELD OF THE INVENTION

This invention relates generally to computer systems and more specifically to a method, a system and an interface that enhances the computing power of computer systems in respect to calculating the position of documents as they are displayed. More precisely, the present invention relates to a method of reducing or minimizing the computing power necessary to identify the position of documents as they are graphically displayed on a display.

### BACKGROUND OF THE INVENTION

Computers have become increasingly important to modern life, defining the way in which humans obtain, explore, create and share information with others. These tasks are primarily carried out via computer display screens, which come in various shapes and sizes in dependence of the type of computers used. Some are larger, such as desktop computers, and some are relatively small, such as mobile phone screens.

Since their inception, the quality and efficiency of computers have increased tremendously. Among other things, their computing power has improved significantly over time. Namely, the speed in which they are able carry out various tasks and the quantity and complexity of the tasks their processors can compute have improved a great deal. This makes possible for one to view a relatively large amount of content on display screens. These days, videos, emails, images, websites, to name a few, may be simultaneously displayed and navigated on a computer display.

The number, size and complexity of such documents to be viewed on computer display screens are expected to increase as a result of the demand for a greater amount and more complex information to be explored on computer screens and for better, more rapid and more functional ways to do so. Faster and more efficient computing abilities from the part of computer systems are therefore desirable to meet this very demand.

Moreover, more and more computers are displaying documents in a rectilinear fashion, on axes of documents which may run horizontally or vertically on screens. Documents may be added or removed on these axes at any moment, which addition or removal thereof may be visible on display screens. United States Patent Application Publication No.: US20070214169A1, published on Sep. 13, 2007, discloses a Multi-dimensional location system and method (title). The respective application provides ways for managing and displaying axes of documents and other computer-readable files. It describes an axis of documents that groups a plurality of documents and other computer-readable files in a predetermined intuitive fashion.

The number of documents displayed on an axis may increase significantly from a relatively small amount of documents to a relatively greater amount of documents in a matter of seconds or even less. Similarly, it may also decrease from a relatively greater number of documents to a relatively smaller number thereof. The increase or decrease of the number of documents displayed on an axis may be caused, for example, by the addition or removal of documents by the user, other users who share access rights to the axis, or by the system.

With the addition or removal of new documents on an axis, the positions of the remaining documents on the respective axis change. The computer system, as a result, must compute the respective new positions of the remaining documents in an expeditious manner so that it would identify the new coordinates these documents should occupy on the axis. This is so that the transition from a small to a greater number of documents displayed on a given axis and vice versa may be carried out smoothly for the viewer of the screen. The faster the system would compute the new positions of the respective documents, the faster they would move to their respective new locations and the smoother the actual transition from a small to a relatively larger number of documents and vice versa would appear to the viewer of the screen.

Every time the position of a document on a given axis of documents changes, the system must recalculate the position of the respective document on the axis. The re-calculation of the new coordinates of the document requires time for it to be carried out by the system. When the system must recalculate the position of a significant number of documents on a plurality of axes, however, the time needed to carry out the recalculations is even greater. As a consequence, the graphical display of documents as a result of the recalculation of their position would require a greater amount of time and may look to the user cumbersome, irregular, and far from continuous and fluid when carried out.

It is therefore desirable to have a mechanism based upon which the update of the position of documents on axes of documents as a result of the addition or removal of other documents on these respective axes would not require the recalculation of the positions thereof.

It is therefore desirable to have a system capable to carry out the necessary computation calculations of documents in an optimal and rapid manner without the need of recalculating the position of the documents thereof every time their position on the axes is updated.

The present invention relates to a method designed to optimize the computing power necessary from the part of the system to carry out graphically a smooth and rapid transition between a small number of documents to a relatively larger number of documents and vice versa displayed on screens, and to a system and a user interface adapted to carry out these methods. This is to ensure that the user experience is subject to little or no discomfort that may result from an abrupt change in the number of documents on the display screen.

Other deficiencies will become apparent to one skilled in the art to which the invention pertains in view of the following summary and detailed description with its appended figures.

### SUMMARY OF THE INVENTION

It is one aspect of the present invention to alleviate one or more of the shortcomings of background art by addressing one or more of the existing needs in the art.

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

In accordance with at least one embodiment of the invention, the present invention is generally described using a plurality of documents aligned in a linear or non-linear fashion, named an axis of documents. An axis of documents generally refers to, but is not limited to, a graphical layout of documents, embodied generally as a rectilinear arrangement of documents thereof. Moreover, an axis, although generally straight and horizontally aligned, may not be necessarily depicted as such. It preferably, however, may have a straight appearance exhibiting to the viewer a sense of continuity, wherein documents are displayed in a predetermined fashion based on a given collation unit, which may or may not be chronological in nature. Furthermore, an axis may embody a single, two or more than two axes, aligned adjacently to each other, referred herein as a group of axes. An axis may be straight, slightly or substantially curved, angled, designed based on a specific shape or shapes. An axis tends to have a consistent shape based upon which documents displayed herein may be exhibited to the viewer. The embodiments of the present invention display axes horizontally. Nevertheless, such axes may be displayed on display screens vertically, diagonally or in any other fashion.

This invention also refers to user-selectable elements that might represent computer-readable files like documents and multimedia assets. Information elements can alternatively be referred to as user-selectable elements, menu elements, icons or thumbnails that are associated to an attribute, a category or a tag and are arranged as explained below. In order to lighten the reading of the present specification, the term “document” is generally used without intending to limit the scope of the present patent application only to documents, unless expressly specified.

In accordance with at least one embodiment of the invention, the invention relates generally to computer systems and more specifically to a method, a system and an interface that enhances the computing power of computer systems in respect to calculating the position of documents as they are displayed on computer screens in reference to the beginning of the group of axes of documents upon which they are displayed. More precisely, the present invention relates to a method of reducing or minimizing the computing power necessary by computer systems to identify the position of documents as they are graphically displayed on computer screens, where the user may use at least one navigation function over the groups of axes. The goal of the present invention is to improve the performances of rendering and updating axes. Moreover, it tends to improve the user experience, either by having more fluid animations or by accepting a larger number of documents on axes, in relation to the display screen and the documents displayed herein.

In accordance with at least one embodiment of the invention, the present invention refers most of the time to a computing function or a plurality thereof adapted to calculate the position of documents on axes of documents when the position thereof on the axis requires to be changed as a result of the navigation over groups of axes.

In accordance with at least one embodiment of the invention referred to below, the invention provides a means for updating the position of documents on a display screen without the need to recalculate the position thereof on the axes.

In accordance with at least one embodiment of the invention referred to below, the invention provides at least a mechanism, a method, an apparatus, a system and or graphical user interface adapted to compute the position of at least one document on at least one axis of documents in respect to the beginning of the group of axes of documents upon which it is displayed.

At least one embodiment of the invention provides a mechanism adapted to graphically display the animated movement of at least one element within at least one axis of documents on the display screen as a result of its displacement caused the navigation over the groups of axes.

At least one embodiment of the invention provides a mechanism adapted to compute the position of at least one document on at least one axis of documents after the magnification of the at least one axis of documents.

At least one embodiment of the invention provides a mechanism adapted to graphically display the magnification in an animated fashion of at least one axis of elements and of the elements of which it consists.

At least one embodiment of the invention provides a mechanism adapted to compute the position of at least one document on at least one axis of documents after the contraction of the at least one axis of documents.

At least one embodiment of the invention provides a mechanism adapted to graphically display the contraction in an animated fashion of at least one axis of elements and of the elements of which it consists.

At least one embodiment of the invention provides a mechanism adapted to compute and graphically display the magnification of at least two axes with different document sizes on the display area.

At least one embodiment of the invention provides a mechanism adapted to compute and graphically display the contraction of at least two axes with different document sizes on the display area.

At least one embodiment of the invention provides a mechanism adapted to improve the system's performance in graphically changing the position of at least one document on at least one axis of documents that is animated to reflect an insertion and/or removal of documents.

At least one embodiment of the invention provides icons and any other user selectable elements adapted to graphically display axes of elements as being magnified.

At least one embodiment of the invention provides icons and any other user selectable elements adapted to graphically display axes of elements as being reduced in size.

An embodiment referred to below provides a product comprising a machine-readable medium; a machine-executable instructions for causing a computer to perform a method comprising calculating the position of at least one element on an axis by computing its position in respect to the beginning of the axis mentioned herein.

An embodiment referred to below provides a product comprising a machine-readable medium; a machine-executable instructions for causing a computer to perform a method comprising modifying the position of at least one element on an axis by computing its position in respect to the beginning of the axis mentioned herein.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

It is one aspect of the invention to alleviate one or more of the drawbacks of the background art by addressing one or more of the existing needs in the art.

Additional and/or alternative features, aspects, and advantages of embodiments of the present invention will become apparent from the following description, the accompanying drawings, and the appended claims.

### DESCRIPTION OF THE DRAWINGS

FIG. 1 is a schematic illustration of an exemplary network;

FIG. 2 is a schematic illustration of an alternate exemplary network;

FIG. 3 is a schematic illustration of an exemplary computer system;

FIG. 4 is a schematic illustration of an exemplary software system;

FIG. 5 is a schematic illustration of an axis-based interface and operating system;

FIG. 6 is a schematic illustration of an exemplary axis layout;

FIG. 7 is a schematic illustration of an exemplary axes layout.

FIG. 8 is a schematic illustration of the layout of several exemplary axes groups.

FIG. 9 is a schematic illustration of the layout of several exemplary axes groups.

FIG. 10 is a schematic illustration of a layout of several exemplary axes groups.

FIG. 11 is a schematic illustration of a layout of several exemplary axes groups, wherein the axes of one axes group are subject to magnification.

FIG. 12 is a schematic illustration of a layout of several exemplary axes groups, wherein the axes of one axes group are being magnified.

FIG. 13 is a schematic illustration of a layout of several exemplary axes groups, wherein one of the axes within one of the groups is subject to magnification.

FIG. 14 is a schematic illustration of a layout of an axes group, wherein the position of the documents within its axes are being defined based on the beginning of the axes.

FIG. 15 is a schematic illustration of layout of an axes group, wherein the display area is subject to movement.

FIG. 16 is a schematic illustration of a layout of an axes group in accordance with an embodiment of the present invention.

FIG. 17 is a schematic illustration of a layout of an axes group in accordance with an embodiment of the present invention.

FIG. 18 is a schematic illustration of a layout of an axes group in accordance with an embodiment of the present invention.

FIG. 19 is a schematic illustration of a layout of an axes group in accordance with an embodiment of the present invention.

FIG. 20 is a schematic illustration of a layout of an axes group in accordance with an embodiment of the present invention.

FIG. 21 is a schematic illustration of a layout of an axes group in accordance with an embodiment of the present invention.

FIG. 22 is a schematic illustration of a layout of an axes group in accordance with an embodiment of the present invention.

FIG. 23 is a schematic illustration of a layout of an axes group in accordance with an embodiment of the present invention.

### DESCRIPTION OF THE EMBODIMENTS OF THE INVENTION

Our work is now described with reference to the figures. In the following description, for purposes of explanation, numerous specific details are set forth in order to provide a thorough understanding of the present invention by way of embodiment(s). It may be evident, however, that the present invention may be practiced without these specific details. In other instances, when applicable, well-known structures and devices are shown in block diagram form in order to facilitate describing the present invention.

The features provided in this specification mainly but might not exclusively relate to principles of computer software and machine-readable code/instructions adapted to instruct a computer, many computers or other machines adapted to use the instructions to provide material effects on a display, or other means enabling human-computer interactions to manage documents, menus, user-selectable elements and other computer files. These code/instructions are preferably stored on a machine-readable medium to be read and acted upon with a computer or machine having the appropriate code/instructions reading capability.

### Exemplary Network

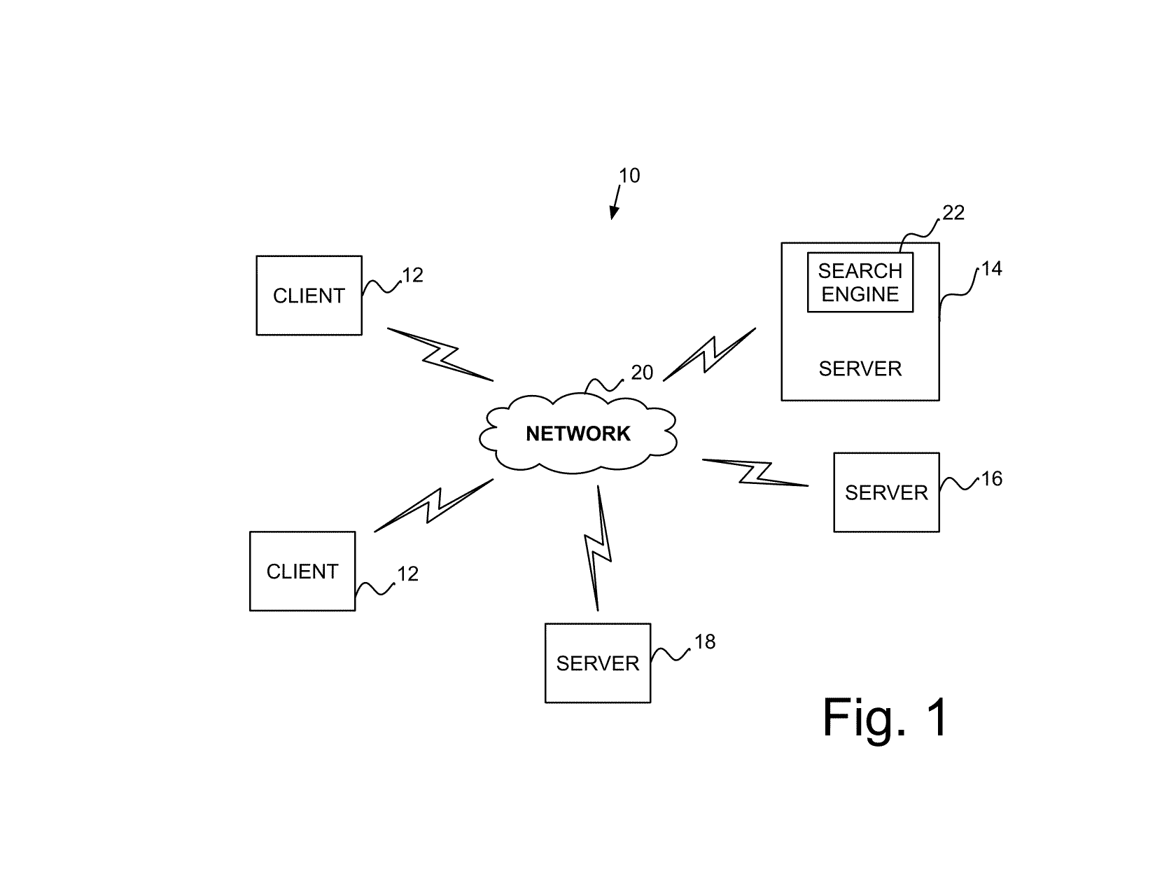

FIG. 1 illustrates an exemplary network 10 in which a system and a method, consistent with the present invention, may be implemented. The network 10 may include multiple client devices 12 connected to multiple servers 14, 16, 18 via a network 20. The network 20 may include a local area network (LAN), a wide area network (WAN), a phone network, such as the Public Switched Phone Network (PSTN), an intranet, the Internet, Wi-Fi, WiMAX or a combination thereof. Two client devices 12 and three servers 14, 16, 18 have been illustrated as connected to network 20 for simplicity. In practice, there may be more or less client devices and servers 14, 16, 18. Also, in some instances, a client 12 device may perform the functions of a server 14, 16, 18 and a server 14, 16, 18 may perform the functions of a client 12 device.

The client devices 12 may include devices such as mainframes, minicomputers, personal computers, laptops, personal digital assistants, phones, or the like, capable of connecting to the network 20. The client devices 12 may transmit data over the network 20 or receive data from the network 20 via a wired, wireless, or optical connection.

The servers 14-18 may include one or more types of computer systems, such as a mainframe, minicomputer, or personal computer, capable of connecting to the network 20 to enable servers 14-18 to communicate with the client devices 12. In alternative implementations, the servers 14-18 may include mechanisms for directly connecting to one or more client devices 12. The servers 14-18 may transmit data over the network 20 or receive data from the network 20 via a wired, wireless, or optical connection.

In an implementation consistent with the present invention illustratively embodied herein, the servers 14-18 may include a search engine 22 usable by the client devices 12. The servers 14-18 may store documents 200, such as web pages, accessible by the client devices 12.

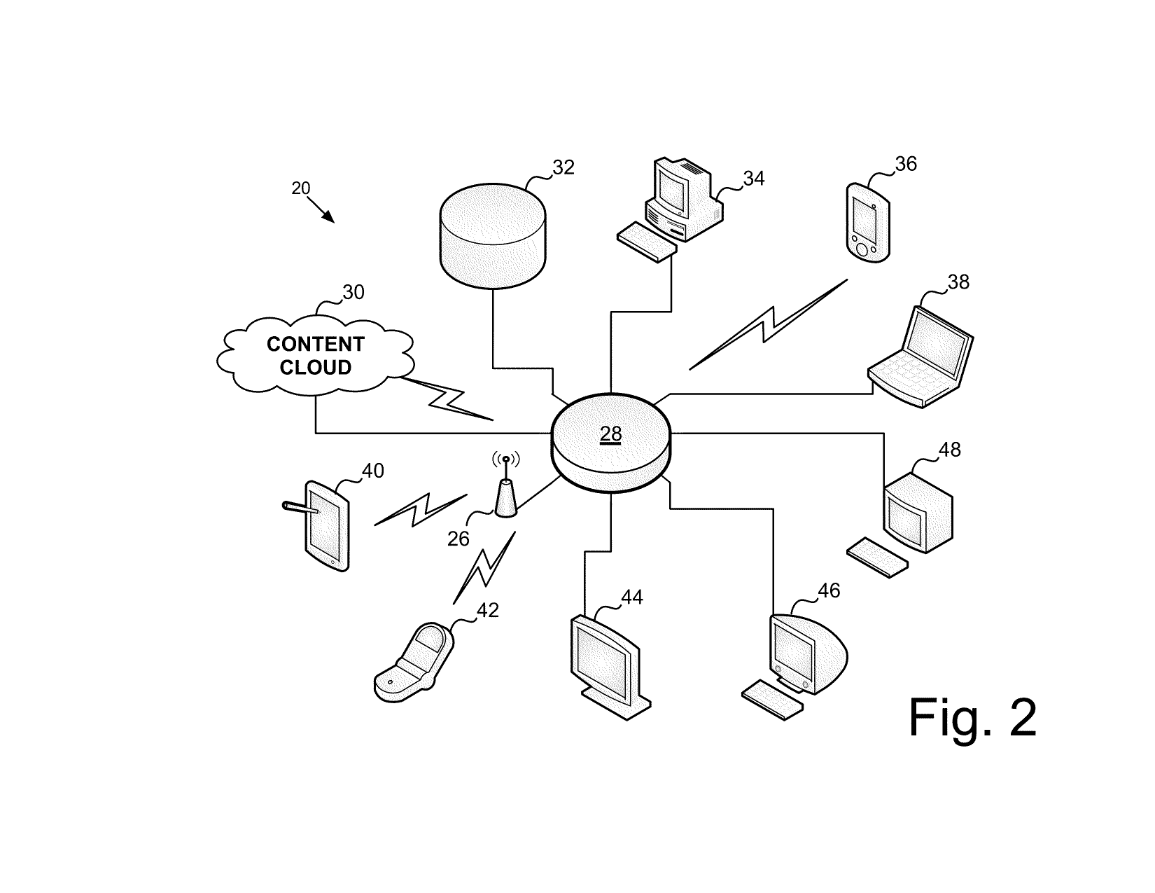

With reference to FIG. 2, a network 20 includes the content cloud 30, a content database 32, content devices 34-38, and other devices 40-48. The network mediator 28 enables network devices 34-48 to communicate with each other without pre-configuring each device 34-48. The content cloud 30 represents a content source such as the Internet, where content exists at various locations across the globe that could be reached through a wired connection and/or with a wireless connection provided by an antenna 26. The content includes multimedia content such as audio and video. The mediator 28 allows the content cloud to provide content to devices 34-48. The database 32 is a storage device 166 that maintains content. The database 32 may be a standalone device on an external communication network. The mediator 28 communicates with the database 32 to access and retrieve content. The content devices 34-48 include intelligent devices, such as, for example, personal computers, laptops, cell phones and personal digital assistants. The content devices 34-48 are capable or storing content data. The devices 34-48 are intelligent devices that receive content from other content devices 30-48. However, the devices 34-48 can also operate as servers to distribute content to other client devices if desirable.

### Exemplary Client Architecture

The following discussion provides a brief, general description of an exemplary computer apparatus in which at least some aspects of the present invention may be implemented. The present invention will be described in the general context of computer-executable instructions, such as program modules 174 being executed by a computerized device. However, methods of the present invention may be affected by other apparatuses. Program modules may include routines, programs, objects, components, data structures, applets, WEB 2.0 type of evolved networked centered applications, etc. that perform a task(s) or implement particular abstract data types. Moreover, those skilled in the art will appreciate that at least some aspects of the present invention may be implemented with other configurations, including hand-held devices, multiprocessor system, microprocessor-based or programmable consumer electronics, network computers, minicomputers, set top boxes, mainframe computers, gaming consoles and the like. At least some aspects of the present invention may also be carried out in distributed computing environments where tasks are performed by remote processing devices linked through a communications network as exemplified in FIG. 2. In a distributed computing environment, program modules 174 may be located in local and/or remote memory storage devices 166.

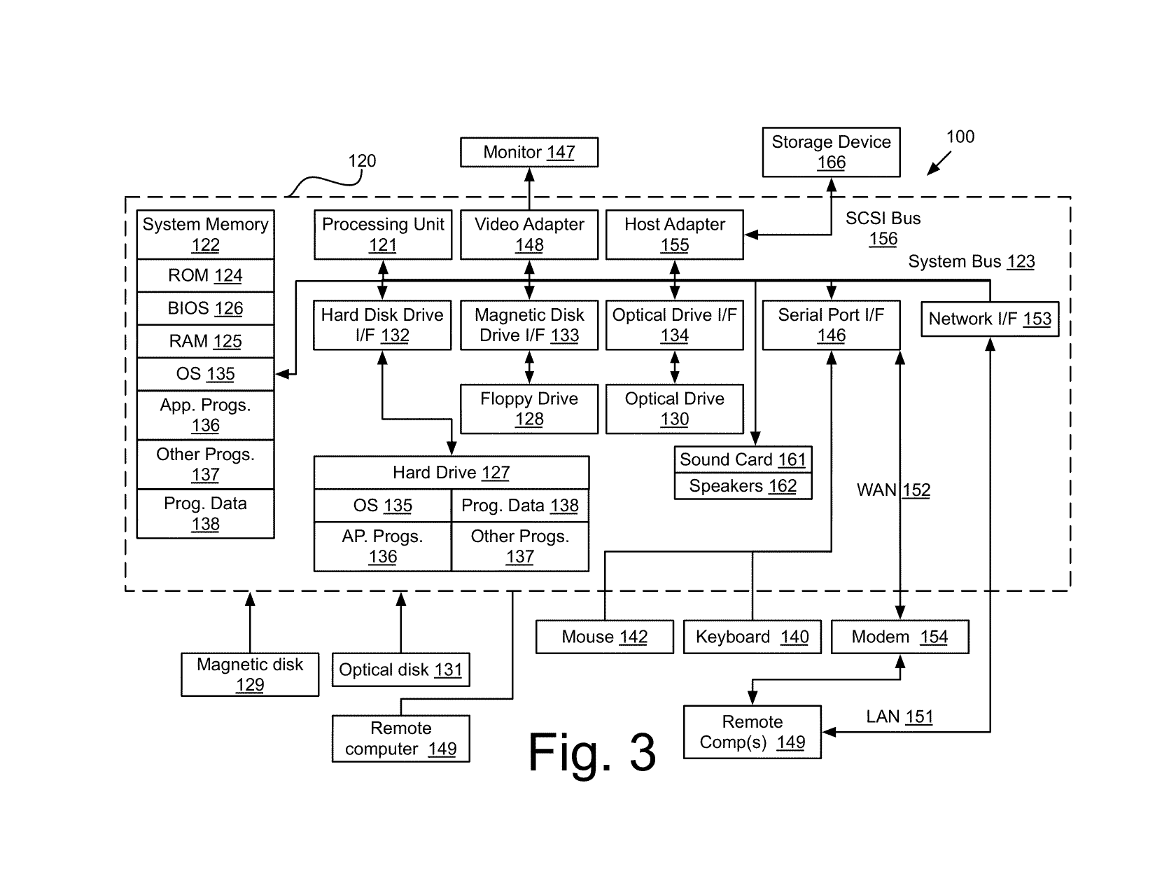

With reference to FIG. 3, an exemplary apparatus 100 for implementing at least some aspects of the present invention includes a general-purpose computing device in the form of a computer 120 or in the form of a computerized portable apparatus. The computer 120 may include a processing unit 121, a system memory 122, and a system bus 123 that couples various system components, including the system memory 122, to the processing unit 121. The system bus 123 may be any of several types of bus structures including a memory bus or memory controller, a peripheral bus, and a local bus using any of a variety of bus architectures. The system memory may include read only memory (ROM) 124 and/or random access memory (RAM) 125. A basic input/output system 126 (BIOS), containing basic routines that help to transfer data between elements within the computer 120, such as during start-up, may be stored in ROM 124. The computer 120 may also include a hard disk drive 127 for reading from and writing to a hard disk, (not shown), a magnetic disk drive 128 for reading from or writing to a (e.g., removable) magnetic disk 129, and an optical disk drive 130 for reading from or writing to a removable (magneto) optical disk 131 such as a compact disk or other (magneto) optical media. The hard disk drive 127, magnetic disk drive 128, and (magneto) optical disk drive 130 may be coupled with the system bus 123 by a hard disk drive interface 132, a magnetic disk drive interface 133, and a (magneto) optical drive interface 134, respectively. The drives and their associated storage media provide non-volatile (or persistent) storage of machine-readable instructions, data structures, program modules 174 and other data for the computer 120. Although the exemplary environment described herein employs a hard disk, a removable magnetic disk 129 and a removable optical disk 131, those skilled in the art will appreciate that other types of storage media, such as magnetic cassettes, flash memory cards, digital video disks, Bernoulli cartridges, random access memories (RAMs), read only memories (ROM), remote cloud storage and the like, may be used instead of, or in addition to, the storage devices 166 introduced above.

A number of program modules 174 may be stored on the hard disk 127, magnetic disk 129, (magneto) optical disk 131, ROM 124 or RAM 125, such as an operating system 135 (for example, Windows® NT® 4.0, sold by Microsoft® Corporation of Redmond, Wash.), one or more application programs 136, other program modules 137 (such as Alice™, which is a research system developed by the User Interface Group at Carnegie Mellon University available at www.Alice.org, OpenGL® from Silicon Graphics Inc. of Mountain View Calif., or Direct 3D from Microsoft Corp. of Bellevue Wash.), and/or program data 138 for example.

A user may enter commands and data into the computer 120 through input devices, such as a keyboard 140, a camera 141 and a pointing device 142 Other input devices (not shown) such as a microphone, joystick, game pad, satellite dish, scanner, a touch sensitive screen, accelerometers or a motion-sensor detector such as KINECT™ that are adapted to sense movements of the user or movements of a device, or the like, may also be included. These and other input devices are often connected to the processing unit 121 through a serial port interface 146 coupled to the system bus 123. However, input devices may be connected by other interfaces, such as a parallel port, a game port, blue tooth connection or a universal serial bus (USB). For example, since the bandwidth of the camera 141 may be too great for the serial port, the video camera 141 may be coupled with the system bus 123 via a video capture card (not shown). The video monitor 147 or other type of display device 150 may also be connected to the system bus 123 via an interface, such as a video adapter 148 for example. The video adapter 148 may include a graphics accelerator. One or more speakers 162 may be connected to the system bus 123 via a sound card 161 (e.g., a wave table synthesizer such as product number AWE64 Gold Card from Creative® Labs of Milpitas, Calif.). In addition to the monitor 147 and speaker(s) 162, the computer 120 may include other peripheral output devices (not shown), such as a printer, a hi-definition television and a scanner for example. As an alternative or an addition to the video monitor 147, a stereo video output device, such as a head mounted display or LCD shutter glasses for example, could be used.

The computer 120 may operate in a networked environment defining logical connections to one or more remote computers 120, such as a remote computer 149. The remote computer 149 may be another computer 120, a server 14-18, a router, a network PC, a peer device or other common network node, and may include many or all of the elements described above relative to the computer 120. The logical connections depicted in FIG. 3 include a local area network (LAN) 151 and a wide area network (WAN) 152, an intranet and the Internet.

When used in a LAN, the computer 120 may be connected to the LAN 151 through a network interface adapter (or “NIC”) 153. When used in a WAN, such as the Internet, the computer 120 may include a modem 154 or other means for establishing communications over the wide area network 152 (e.g. Wi-Fi, WinMax). The modem 154, which may be internal or external, may be connected to the system bus 123 via the serial port interface 146 or another type of port interface. In a networked environment, at least some of the program modules depicted relative to the computer 120 may be stored in the remote memory storage device 166. The network connections shown are exemplary and other means of establishing a communications link between the computers 120 may be used.

The exemplary network and the exemplary computer system described above are adapted to carry on the following embodiments:

### The System

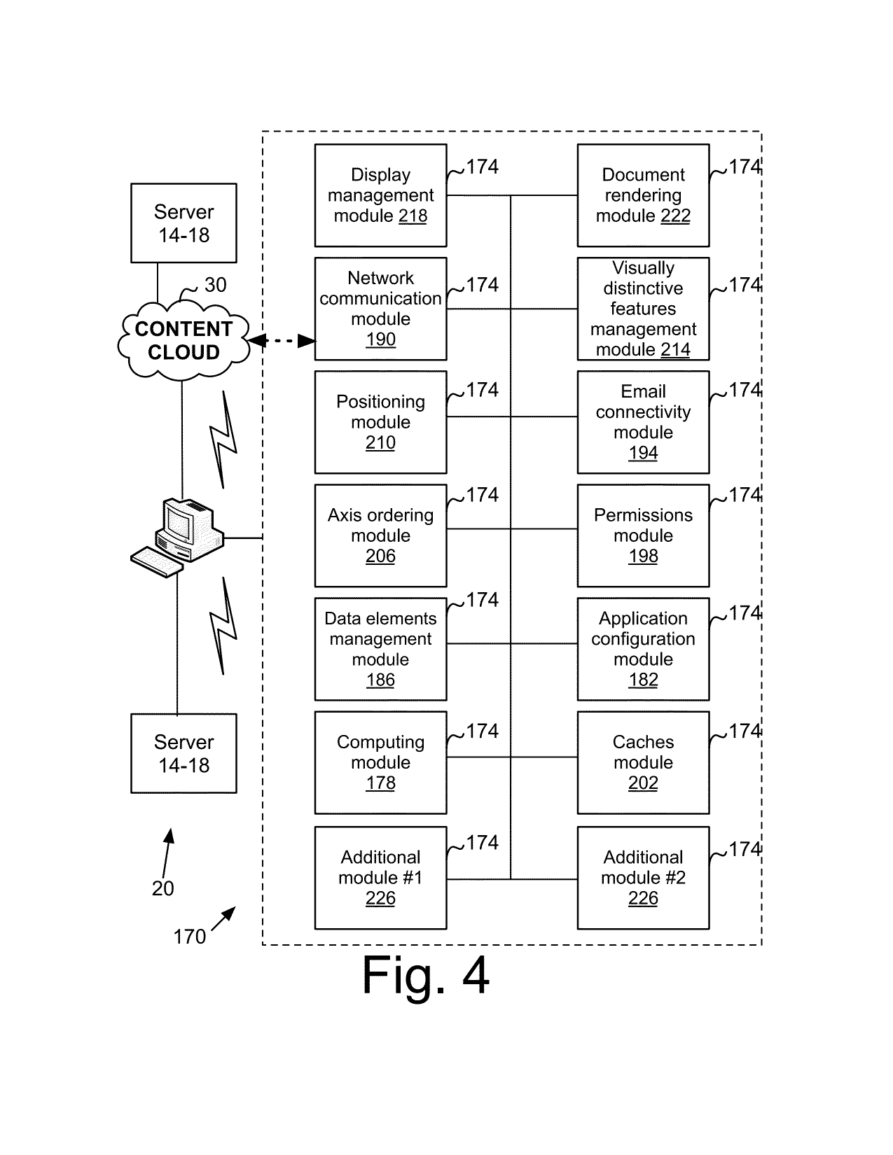

A system 170 is depicted in FIG. 4 which may represent the functionalities described in the instant application when run on an apparatus 100, for instance a computer 120, such as has been previously described. The computer 120 may in turn be connected to a server 14-18 comprising a set of program modules 174 enabling functions including but not limited to: computing, document rendering, network communication, application configuration and local database management.

The software system 170 illustratively consists of a collection of at least twelve modules 174 independent from those of the server 14-18 that together carry out the method required for the functionalities to be visible on a graphical user interface and usable by the user. As illustrated, additional modules 226 may also be used in conjunction with the twelve base modules.

A computing module 178 provides a means to circulate data between users, the other modules 174 and the apparatus 100. The computing module 178 is adapted to convert queries 230, which may be system-based or user-based, into graphical rendering in accordance with at least one embodiment of the present invention. The other modules 174 are configured to send to and receive data from the computing module and to individually or collectively interact with other modules 174.

An application configuration module 182 provides software configuration to manage application settings and open connections to other servers 14-18. Other modules 174 may use the application configuration module 182 to manage their behavior to satisfy user-specific needs.

A data elements management module 186 may be used in conjunction with other modules to manage data elements such as documents 200 contained in a database 32 in response to a query 230. The data elements management module 186 may use any kind of database connection and may use a network communication module 190 in order to access a database 32 through a network 28, on a server computer 14-18. The network communication module 190 may use several protocols in order to communicate with a server computer 14-18, such as IPv4, IPv6, TCP, UDP, ODBC, HTTP, WebDAV, SSH, IMAP and even define its own specific communication protocol. The data elements management module 186 may also be used in conjunction with an email connectivity module 194 and network communication module 190 in order to treat and represent emails in the same way as the data elements of a database 32. The data elements management module 186 may also be used in conjunction with the permissions module 198 (on the client or server side) in order to control the user access to elements based by some sort of sharing rules. The data elements management module 186 may also work in conjunction with a caches module 202, providing client-side cached versions of the database 32 and files in order to respond to future requests faster. Modules 174 may be made to communicate information in a standardized way by the use of an Application Programming Interface (API) in order to simplify the data elements management module's 186 interactions with other modules 174.

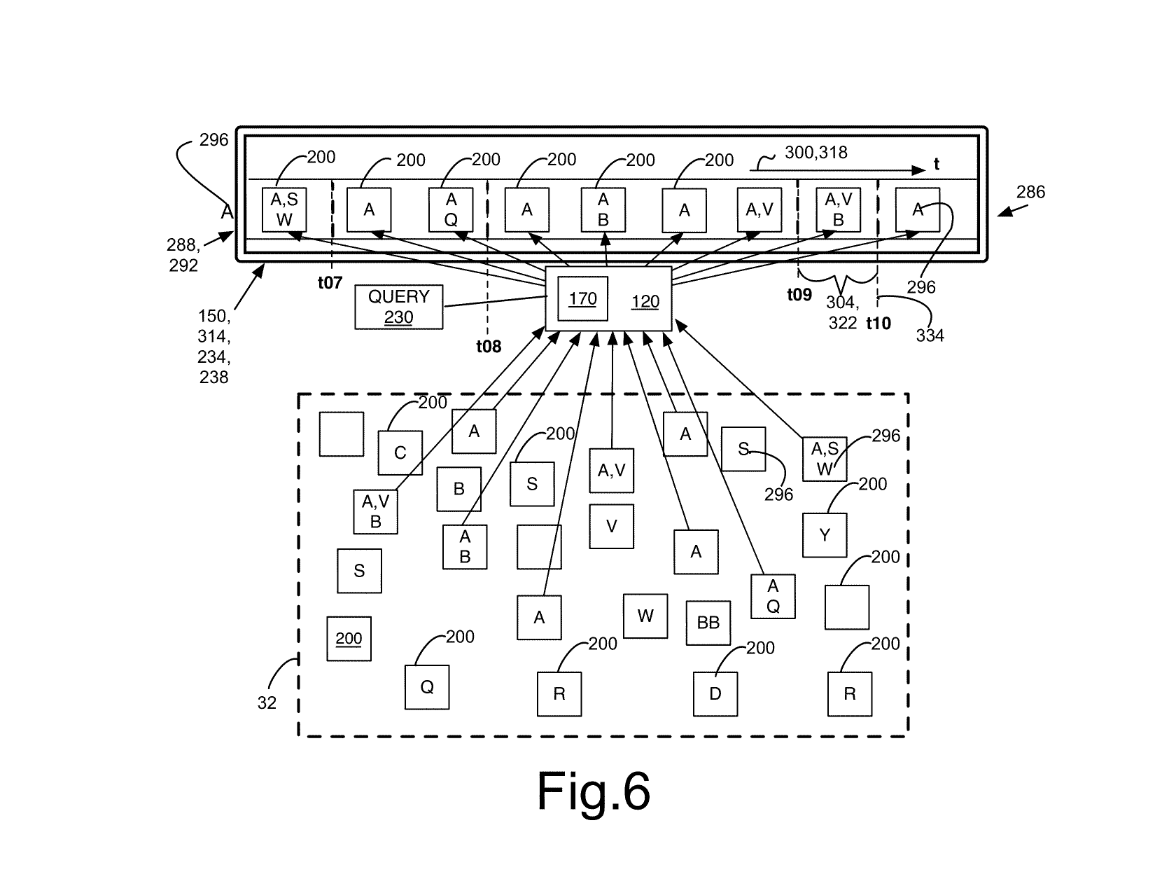

The data elements management module 186 may sort through documents 200 stored in the database 32 and connected to each other via a variety of referencing modes, may apply a filter as specified in a query 230 and may subsequently direct the filtered documents 200 to other modules 174 (this will be shown in FIG. 6). One such module may be an axis-ordering module 206 which may distribute documents 200 filtered by the data elements management module 186 onto an axis-like array 288 or axis 292 (illustrated in FIG. 6) according to a collation function that may be user- or system-specified and analyzed by the computing module 178. An axis 292 or axis-like array 288 is an embodiment of graphical rendering of the functionalities described in the present specification on a device's display 150 that can be embodied as a substantially rectilinear sequence of documents 200 from which a viewer can infer meaning and/or relationships therebetween. An axial distribution 292 of documents 200 is adapted to accommodate and display a single type of documents 200 or, if desirable, more than one type of documents 200, computer files, multimedia contents, user-selectable elements and/or user-selectable menu elements. Generally, an axis 292 is used to graphically group information elements 200 having a commonality. Other functionalities related to axes 292 shall be described in greater detail below.

The axis-ordering module 206 may manage the ordering of single documents 200 and/or several documents 200 assembled into document sets 220 onto one or more axes 292. In addition of managing the collation of documents 200 onto an axis 292, the axis-ordering module 206 may also manage the order of the documents 200 contained within secondary documents sets 232 (not illustrated). The positioning module 210 manages the positioning of documents 200 within axes 240 based on interactions with other modules 174 processing the various elements contained in a query 230. The positioning module 210 is adapted to and may interpret data contained in document sets 228 generated by the data elements management module 186 in relationship to the query 230 to identify a location for a given document set 228 within the collation of an axis 292. Likewise, a visually distinctive features management module 214 is adapted to interpret data contained in documents 200 or document sets 228 generated by the data elements management module 186 in relationship to the query 230 to selectively apply one or more visually distinctive features 284 (not illustrated in this figure) to single documents 200 or document sets 228. Finally, a display management module 218 may, inter alia, manage elements related to the user interface 234, possibly interacting with a graphics card and a monitor 147. The display management module 218 may use a document-rendering module 222 that provides instructions to render specific documents 200, like images, text files, word-processing files, spreadsheet files, presentation files, etc. The document-rendering module 222 may also provide an API to let developers add their own extensions to deliver to renderers other document types.

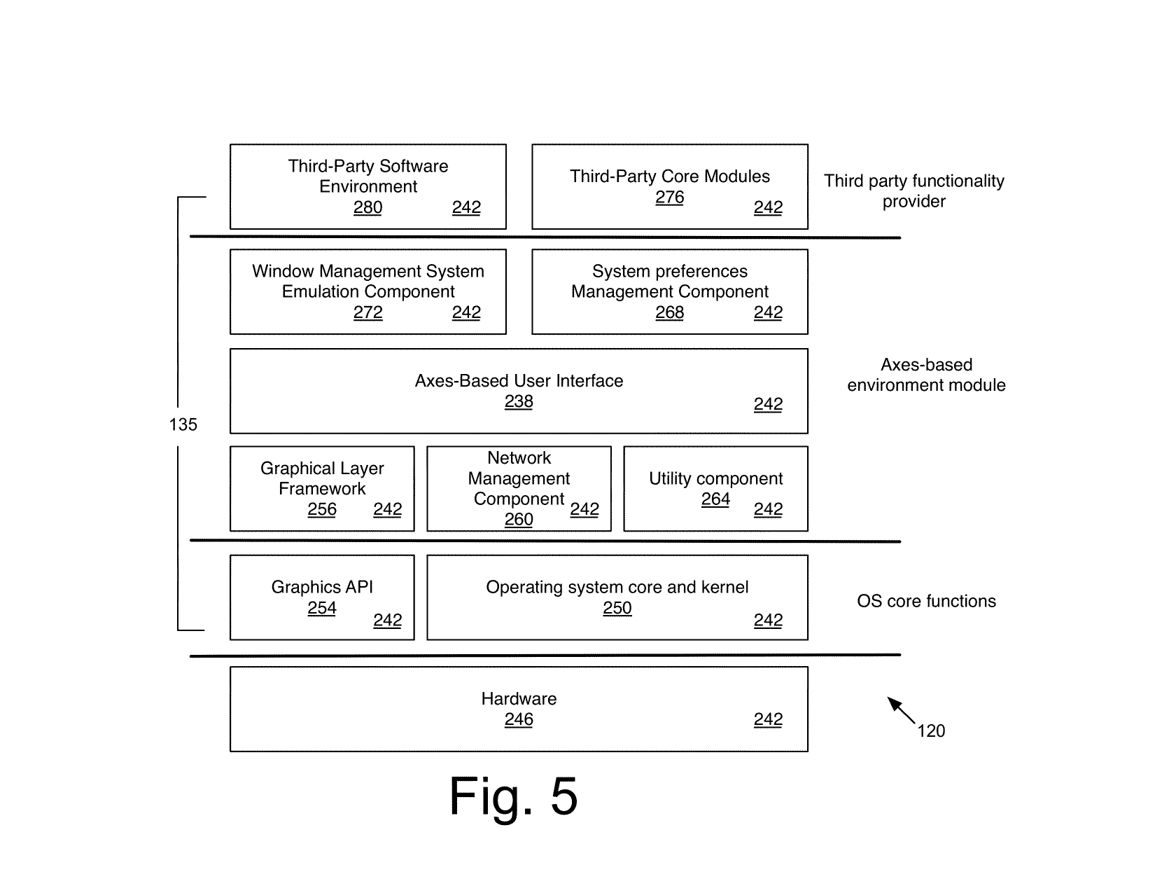

FIG. 5 depicts a computer system 120 comprising an operating system 135 with an integrated axis-based user interface 238. As illustrated in FIG. 5, the axis-based user interface 238 could serve as a desktop environment to manipulate documents 200 (such as files, objects and applications), or could be used as a main operating system 135 user interface 234. One can appreciate a hierarchical description of a computer system 120 and software system 170 with multiple components 242. First, hardware 246 is used to provide users with a physical device 34-48. Second, the axis-based system could be built on top of an existing operating system core and kernel 250, such as, for instance, Unix™ or BSD™. A graphics API 254 like OpenGL® could also be used in order to provide basic graphical capabilities to the system via a video adapter 148.

Multiple core functionalities could be integrated to provide core operating system 135 services. A graphical layer framework component 256 could be built over the graphics API component 254, and could be used to provide complex drawing capabilities. The layer-based graphics layer framework component 256 may also support widget rendering and handling (like buttons, text fields, dialogs, etc.) A network management component 260 could be based on pre-existing network management capabilities in the operating system core and kernel 250. It could serve as a tool to manage an Internet network connection through Ethernet, Bluetooth, Wi-Fi, Modem and other communication channels. A utility component 264 could handle all the other services needed to communicate with the operating system core and kernel 250, providing functionalities such as user login, user authentication, memory, disk-access management, etc. Using these modules, the axis-based user interface 238 would use core functionalities from the graphical layer framework component 256, the network management component 260 and the utility component 264 to provide workspaces 306 comprising multiple axes 292 that display documents 200 (not shown in FIG. 5). The axis-based user interface 238 may also provide more integrated actions, like interface buttons, preview or magnification that may be directly docketed. Another component, a system preferences management component 268 would provide multiple functions needed by the axis-based user interface 238, such as dialogs to manage document insertion, attribute definitions, users, permissions, application configuration, etc. Finally, the operating system 135 may comprise a window management system emulation module 272. This module may be based on an X Window System or X11© and may use other existing client application libraries to provide a large number of applications as well as functionalities to run windowed applications on top of the axis-based user interface 238. To provide other functionalities, third-party application providers could build third-party core modules 276 on top of the axis-based user interface 238 and system preferences management module 268. Third-party application providers could also develop third-party software environments 280 and other applications that could be run using the window management system emulation 272, providing the user with useful applications such as an Internet Browser, Office Business Applications, Multimedia Applications, Games, etc.

The Window Management System Emulation 272 could also offer functions to provide a more axis-based user interface 238 integration, such as, previews, player and editors for the documents 200 displayed in the axis-based user interface 238. For example, a rich text document 200 could use a third-party module 276 or third-party software environment 280 to provide a previewer or media player for the document 200, or a third-party application to integrate a live editor on the axis-based user interface 238.

This computer system 120 could be used, for instance, as a business solution to provide users with an axis-based user interface 238 operating system 135 directly on multiple kinds of devices 34-48 (computers, laptop, tablets, cell phones, etc.). The computer system 120 may also illustratively be used as a business solution to sell preconfigured devices 34-48 with the axis-based user interface 286. Since the operating system 135 has a built-in axis-based user interface 286, the device 34-48 is likely to have a display 150 and other input devices like a keyboard 140, a mouse 142 or a touch-screen interface. The devices 34-48 may not necessarily provide such parts and may be adapted to be used by communicating information about the user interface 240 and input methods with other devices 34-48 (television set, motion sensing input device, computer or tablet over network, cell phone, etc.)

### The Interface

FIG. 6 illustrates the interaction of the computer system 120 and software system 170 with an axis-based graphical user interface 238. An interface program providing a graphical user interface 234 for managing information elements 200 in accordance with an embodiment of the invention is installed on a machine, e.g. a computer system 120 as illustrated in FIG. 3. The interface 234 can be programmed using various programming languages e.g. C++, Java or other suitable programming languages. The programming of these languages is well known in the art and is adapted to be stored on a machine-readable medium and readable therefrom to provide executable instructions to a hardware system. It is believed that a skilled reader in software art is going to recognize this portion of the system that will, therefore, not be further described herein.

The graphical user interface 234 may run through the operating system 135 and the hardware 246 of the computer system 120 or, alternatively, through a network-based system e.g. client-server, and/cloud computing system as exemplified in FIG. 1 and FIG. 2. The interface 234 is adapted to display and manage information elements 200, generally provided on a basis of a query 230, which may be stored in one or many databases 32 (as illustrated in FIG. 6) that might be distributed in a combination of locations (e.g. multiple databases, web, cloud, etc.). Information elements 200 may include computer files, pictures, multimedia content, applications (i.e. computer programs), menu elements, sets of icons and/or other user-selectable elements, all of which shall henceforth be indiscriminately referred to as documents 200 to lighten the text without limiting the scope of the present invention.

An axis-based graphical interface 238 is adapted to graphically structure documents 200 in arrays 288 that arrange the documents 200 in rows and/or columns in a reasonably regular fashion and to allow navigation thereof by the user further to a query 230. The axis-based layout and ordering provide the user with information about the content of each document 200, its meaning and its relationships to the other documents 200 disposed on the axis 292. Navigation tools are provided with the axis-based user interface 238 to allow navigation through the documents 200 of a single axis 292 and of various axes 292 when a plurality of axes 292 is enabled. The display of documents 200 on an array 288, or axis 292, therefore allows contextual management of documents 200 as a flow, or an ongoing rational sequence of documents 200. An axis-based interface 238 thus helps to intuitively display a group of documents 200 and facilitate understanding and managing large sequences of documents 200 bearing a relation.

In a simplified exemplary form, an array 288 may be embodied as an axis of documents 292 (hereinbelow referred to as axis 292 to lighten the text), which groups documents 200 in a single row or column, as illustrated in FIG. 6. An axis 292 can be embodied as a substantially rectilinear arrangement of documents 200 adapted to dispose each document 200 on a straight or curved line. The axis 292 can be embodied as completely straight (rectilinear), slightly curved, substantially curved, circular, angled, following a particular shape or have a consistent shape over which documents 200 are disposed in a reasonably consistent fashion. The exact shape of the axis 292 as well as its disposition can vary—horizontal, vertical or other—in relation to the device's display 150. What matters, inter alia, is that the layout structure of an axis 292 provides a sequence of documents 200 from which a viewer can infer meaning, logical connections, contextual location, and/or relationships.

The axis 292 can be represented as a single axis 292, a double axis 292, or more axes 292. Axes 292 may be independent from one another (using distinct scales, or orderings, henceforth referred to as collation functions 300) or may form a group of axes 310 by sharing the same scale or collation function 300. Also, a document 200, attribute 296 or other property of an element contained in an axis 292 can be selected and used as a logical connector to create an additional axis 292 from an existing axis 292. This subsidiary axis 294 is meant to be temporary in some embodiments, serving as a way to view a specific set of additional documents 200 or highlight certain documents 200 from the original axis 292 without having to alter the entire workspace 306. It may originate from the logical connector document 200 or information element 200 and be disposed in non-parallel fashion thereto. The subsidiary axis's 294 position is preferably orthogonal to the original axis 292. However, the angle may vary. Like axes 292, logically connected axes 294 may be scrollable. More such logically connected axes 2924 can subsequently be created in the same fashion. Navigation among axes 292 and subsidiary axes 294 could be called “relational navigation”.

Axes 292 may be disposed horizontally and/or vertically. Groups of axes 310 may be presented using one of the layouts or combining both. The axes 292 presented in the embodiments below are generally illustrated in the horizontal layout configuration. However, they could, all or in majority, be disposed vertically without departing from the scope of the present disclosure. Other possible graphical layouts of documents 200 might become obvious to a skilled reader in light of the present application and would be considered within the scope of this application.

When only a portion of the axis 292 is visible, a play of zoom, pan and scrolling movements along the axis 292 allows a user to navigate the axis 292 and change the series of documents 200 that are displayed in the display area 314 of the display 150. Scrolling movements can be performed in a variety of ways including but not limited to click-and-drag, pressing on the keys of a keyboard, gesturing to a motion-sensor or on a touch-screen.

Documents 200 might overlap or decrease in size so as to fit or maximize the space available in the display area 314. Selected documents 200 on an axis 292 can be magnified to increase the level of detail shown. Similarly, a small display area 314 could display only one document 200 out of the entire axis 292. The remaining documents 200 would not be shown in the display area 314 but would yet remain at their respective “virtual” position on the axis 292, ready to be displayed upon scrolling the axis 292. In other words, if we consider a mobile platform like a mobile phone having a small display 150, the small display 150 might only allow to efficiently exhibit one document 200 at a time. However, given that the displayed document 200 is part of an axis 292, the other documents 200 on the axis 292 would remain displayable in accordance with their respective position on the axis 292 when the axis is scrolled, navigated, gestured.

The documents 200 are selected to be disposed on the axis 292 on the basis of one or more attributes 296, and are ordered thereon according to a collation function 300, namely an ordered arrangement made by comparison, (e.g. a chronological order adapted to use a time scale 318. The attribute(s) and collation function parameters are specified in a query 230 that may be run by a user or by an automated function of the system. Indeed, each axis 292 groups documents 200 in accordance with, for example, a selected tag, category, keyword, document creator, or other attribute 296 that expresses a characterization of one or more document(s) 200 and that are configurable to represent intrinsic or extrinsic characteristics. The term “attribute” 296 will generally be used throughout the instant specification to lighten the reading of the text and will encompass other document properties or means for establishing commonality or relationships as described above unless otherwise specified.

Attributes 296 may be user-specified or system-specified. Generally, documents 200 bear a plurality of attributes 296 assigned by one or more user(s) (e.g. keyword, subject, project, creator, category, etc.), and a plurality of attributes 296 that are assigned by the system, such as, illustratively, file type, time of creation, number of views, time of last modification, file size, etc. Given the broad range of applicability of the present invention, the attributes 296 that may be assigned by the system and user, as well as the attributes 296 that can be desirable to use in the management of axes 292 might substantially vary from one field or user to another and however remain within the scope of present specification.

The selection of one or more attributes 296 (using Boolean logic for instance) in a query 230 determines which documents 200 will be displayed on the axis 292. If no specific attribute 296 is selected, the axis 292 will display all documents 200 in a default order, like the date of creation thereof. Thus, all documents 200 on the same axis 292 are normally associated with the selected set or combination of attributes 296 that are used as parameters for the axis 292. Third-party data, like publicity or user-targeted information, could also be added to an axis 292, either arbitrarily or according to user information, filtering and/or existing collation of axes 292 without departing from the scope of the present invention.

The documents 200 illustrated in FIG. 6 feature attributes 296 individually represented by a capital letter thereon, or none, in which case the documents 200 are left blank. Letter attributes 296 are used in the present application for illustrative purposes only while letter attributes are theoretically possible. More descriptive attributes 296 such as those described above are used in embodiments of the present invention. As is shown in FIG. 6, any document 200 can simultaneously feature multiple attributes 296, some user-specified and others system-specified. In fact, a preferred embodiment of the invention assigns a plurality of attributes 296 to every document 200. Other documents 200 illustrated on FIG. 6 are blank, or without any associated attribute 296, illustrating documents that could theoretically not be assigned any attribute 296, but that could nonetheless be created and found in a query 230 (e.g. a query 230 that would select all documents 200 contained in the database 32).

The query 230 in FIG. 6 here illustratively filters and selects documents 200 from the database 32 based on attribute 296 ‘A’ for display on the axis 292. FIG. 6 further illustrates that the documents 200 selected from the database 32 by the query 230 are placed on the axis 292 in chronological order 318, another parameter that could be specified in the query 230. Indeed, an axis 292 also generally disposes the documents 200 resulting from the query 230 in accordance with a specified order or collation function 300, (e.g. chronological order, alphabetical order, statistical order, increasing file size, etc.). A collation function 300 might include dividing the axis 292 into successive collation units 304 (e.g. time units 322 in the case of a chronological order, which can illustratively be hours, days, months, years, etc.). A collation function 300 would thus dispose each document 200 along the axis 292 according to the value of a specified attribute 296 in relation to the collation units 304 of the axis 292 and the other documents 200 of the selected document set 228. Among collation functions 300, a chronological distribution of documents 200 on a time scale 318 is used in most embodiments of our work because of its intuitiveness (because any action or event takes place at a specific time and usually in sequence with other events or actions). While an axis 292 disposing documents in random fashion is also contemplated within the scope of the present specification, axes 292 disposing documents 200 according to a collation function 300 are illustrated embodiments because of the usefulness of ordering documents 200.

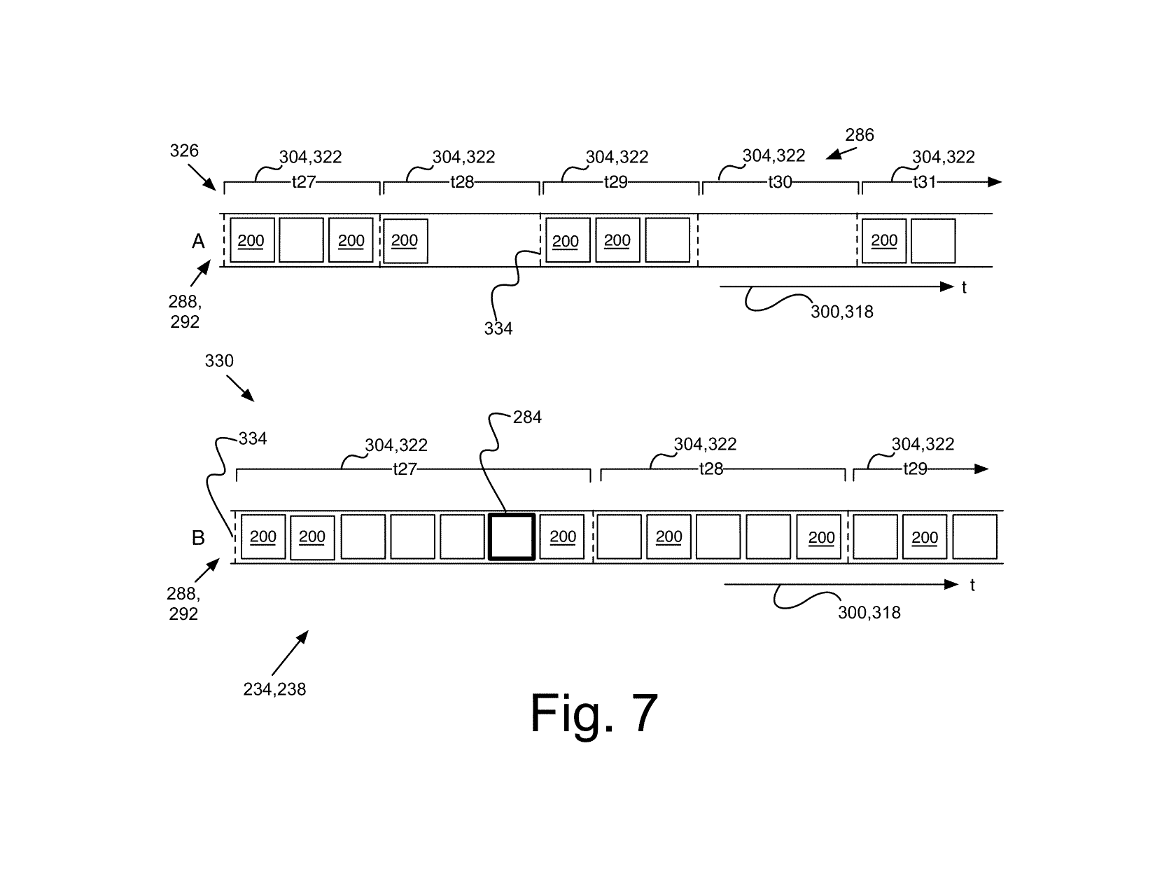

An axis 292 or a group of axes 310 may be embodied in a linear configuration 326 or a non-linear configuration 330. Both configurations are illustrated in FIG. 7 in a generic example. As can be appreciated from FIG. 7, a linear configuration 326 displays collation units 304 of the same graphical longitudinal size regardless of the number of documents 200 contained in each collation unit 304. The size of the documents 200 located within a given collation unit 304 can optionally be adjusted in accordance with the number of documents 200 located therein. For instance, documents 200 will be larger if there are few documents 200 in the collation unit 304 and smaller if many documents 200 are found therein. Alternatively, the documents 200 can remain the same size and can overlap, or be stacked, when their quantity exceeds the available space. Another possible way of making large numbers of documents 200 fit into a fixed-size collation unit 304 is to equip the collation unit 304 with a scroll bar allowing the user to navigate the collation unit 304 to reveal hidden documents 200. This also means that documents 200 in a linear configuration 326 may be displayed as an uneven sequence from a graphical point of view. Ultimately, a collation unit 304 in a linear configuration containing no document will appear as empty, or as a blank space on the display 150, but will still be the same size as the other collation units 304 of the axis 292. Conversely, the non-linear configuration 330 displays collation units 304 of uneven longitudinal sizes because an even distribution of documents 200 along the axis 292 prevails over the linearity of the collation. In other words, document 200 size and a constant flow of documents 200 along the axis 292 are given primacy over having collation units 304 of equal graphical size. This provides a more efficient use of the space on the axes 292, but may provide less meaning to illustrate an evolution along time.

FIG. 7 presents a graphical user interface 234. More specifically, it illustrates an axis-based user interface 238 with a linear axis configuration 326. The linear axis configuration 326 shows an axis-like array 288. This is an exemplary illustration of how documents 200 can be presented on a linear axis 292 within and outside of the display area 314.

Documents are not the only items one could find on an axis-like array 288. Videos, menu options, emails and numerous other types of information elements can also be displayed on an axis-like array 288. However, for the purpose of explaining and describing this invention, the Figures presented herein will only reserve to axes 292 with documents 200 only.

In the axis-like array 288, documents 200 are laid out in a linear fashion, based on the framework set out by the collation units 304. By “linear,” we refer to the idea that documents 200 are arranged and extended along a straight horizontal line.

A collation unit 304 collects and combines certain elements on an axis 292. In the case of FIG. 7, the collation units 304 gather and combine documents 200 in a certain predetermined order.

The collation unit 304 is chronological in nature. That is, documents 200 are organized on the axis-like array 288 according to time units 322 (t27, t28, t29, t30 and t31) that are equally spaced. The time scale 318 specifies the division of time. For example, the time division may be structured by hour, day, month, or year.

The collation function 300 makes it possible for time units 322 to align accordingly on the axis 292 based on a certain time scale 318. Moreover, these time units 322 are moving progressively to the right. The time unit markers 334 identify the beginning and end of a time unit 322.

The collation units 304 do not have to be chronological per se. For example, they can be alphabetical as well or based on a certain feature or identity set out by the user.

Some collation units 304 contain more documents 200 than other ones. This is because on a linear axis 292, the collation units 304 are equally spaced from each other and, therefore, of the same length. As a result, it will often be the case that some collation units 304 will be empty and some—full or partially full of documents. This is illustrated in FIG. 7. The time unit t28, for example, contains only one document 200. Time unit t29 is full, while time unit t30 is empty of documents 200. It is thus safe to assume that not all axes displaying documents or any other elements, such the axis of documents 292 depicted in FIG. 7, are comprised of collation units 304 that are equally spaced.

Axes 292 that have non-equally spaced collation units 304 are called non-linear axes 292. Notably, the variation in length of the collation units is the one major distinctive feature that sets non-linear axes 292 apart from the linear ones 292.

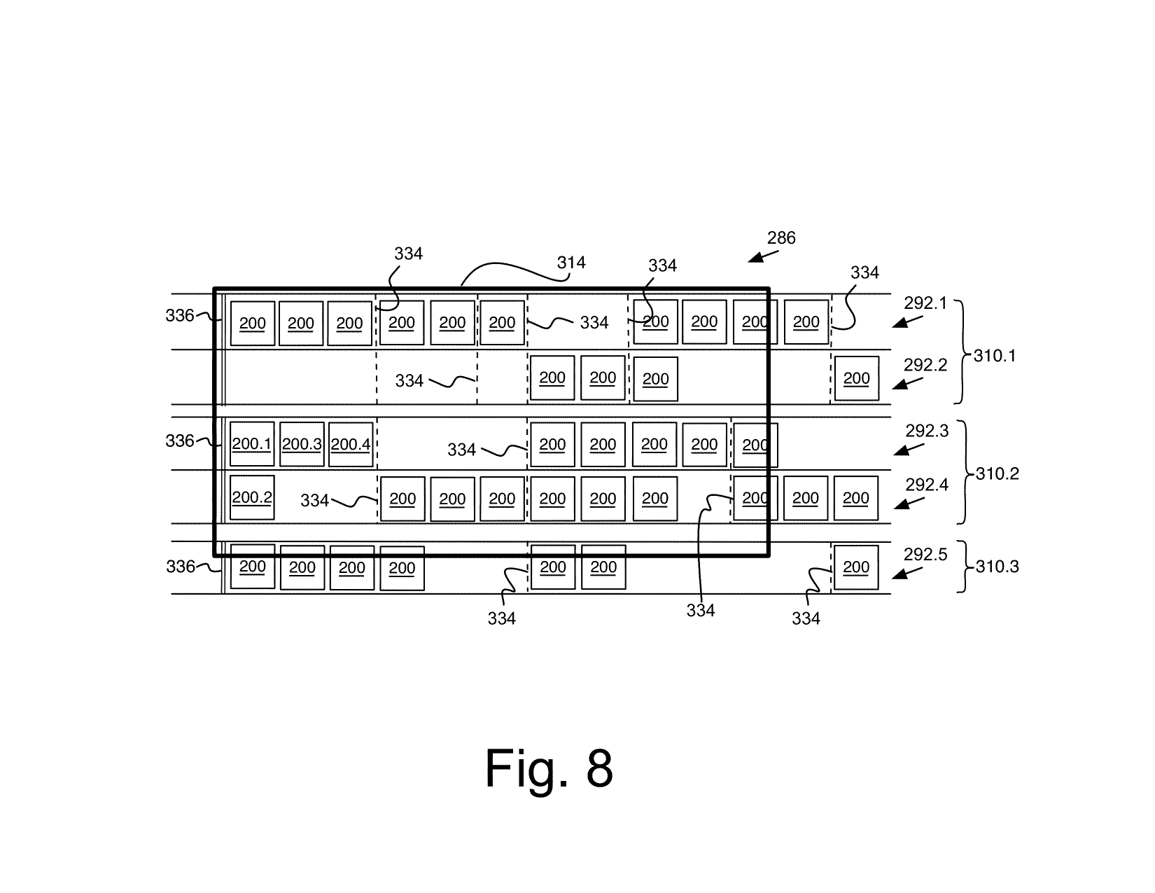

FIG. 8 illustrates two non-linear groups of axes 310.1, 310.2 and one linear group of axes 310.3. The axes group 310.1 contains two axes of documents 292.1 and 292.2. The axes group 310.2 contains two axes of documents 292.3 and 292.4. The axes group 310.3 contains one axis of document 292.5. An axis 292 is defined as linear if it belongs to a linear axes group 310. Similarly, an axis 292 is said to be non-linear if it belongs to a non-linear axes group 310. Moreover, axes groups 310 may consist of only one axis 292.

FIG. 8 more specifically illustrates a display area 314 upon which thirty-four documents 200 belonging to their respective axes 292 may be seen. On the axis 292.1, eight documents 200 are fully and one document 200 is partially visible on the display area 314. On the axis 292.2, three documents 200 are fully visible on the display area 314. On the axis 292.3, seven documents 200 are fully visible on the display area 314 and one document 200 is partially visible on the display area 314. On the axis 292.4, seven documents 200 are fully visible on the display area 314 and one document 200 is partially visible on the display area 314. On the axis 292.5, six documents 200 are fully visible on the display area 314.

Similar to FIG. 7, the documents 200 in FIG. 8 follow a chronological order, defined by the collation unit 304 (not shown in FIG. 8). The collation units 304 are delimited by time unit markers 334. Each collation function 300 and each collation unit 304 are configured differently for each axes group 310.

FIG. 8 shows the three axes groups 310. The beginning of the axes 292, marked by the delimiter 336, is aligned at the left position on the display area 314. This is because the position of the beginning of the axis 336 of each axis 292 coincides with the frame of the display area 314.

For the purpose of clarity, this invention only refers to horizontal axes 292. The invention is not limited to horizontal axes 292 only, as it may be applied to vertical or diagonal axes and/or to a mix of multiple of the possibilities mentioned thereof, located within the same axes group 310 environment. The methods described above could also be applied on axes 292 in a multi-dimensional environment.

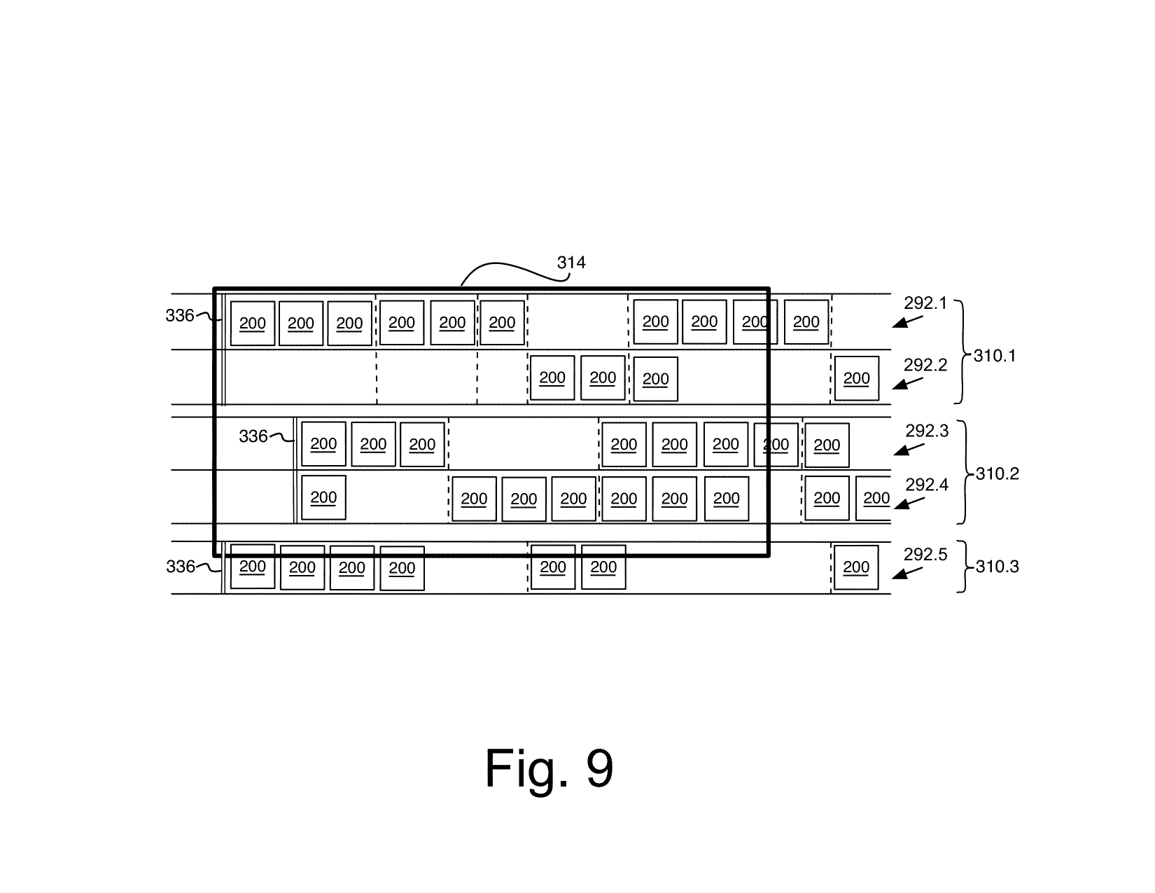

Moving now to FIG. 9. FIG. 9 shows one particular feature of the invention, where axes groups 310 may be moved independently. In FIG. 9, the axes group 310.2 is moved to the right from a certain distance.

Similarly to what is shown in FIG. 9, an axis group 310 may be moved to the left (not shown in the Figures). Also, an axes group 310 may be moved vertically, by creating blank spaces between axes groups 310, overlapping axes groups 310 or reordering axes groups 310.

The actual movement of the axes groups 310 may be caused be the user, for example, or by the system. Other parties, such as a manager or managers, may be causing the movement of the display area 314, the discussion concerning this, however, will not be elaborated further as this is not comprised in the purpose of the invention.

The user may use multiple devices to communicate this movement information, such as keyboards keys, like arrows keys, home key, end key, page up key, page down key, etc. Also, the user may utilize a computer mouse, trackpad and touch-screen gestures to communicate this movement. Similarly, other devices like a remote with acceleromator-based devices, body motion sensors and voice recognition sensors may be applied.

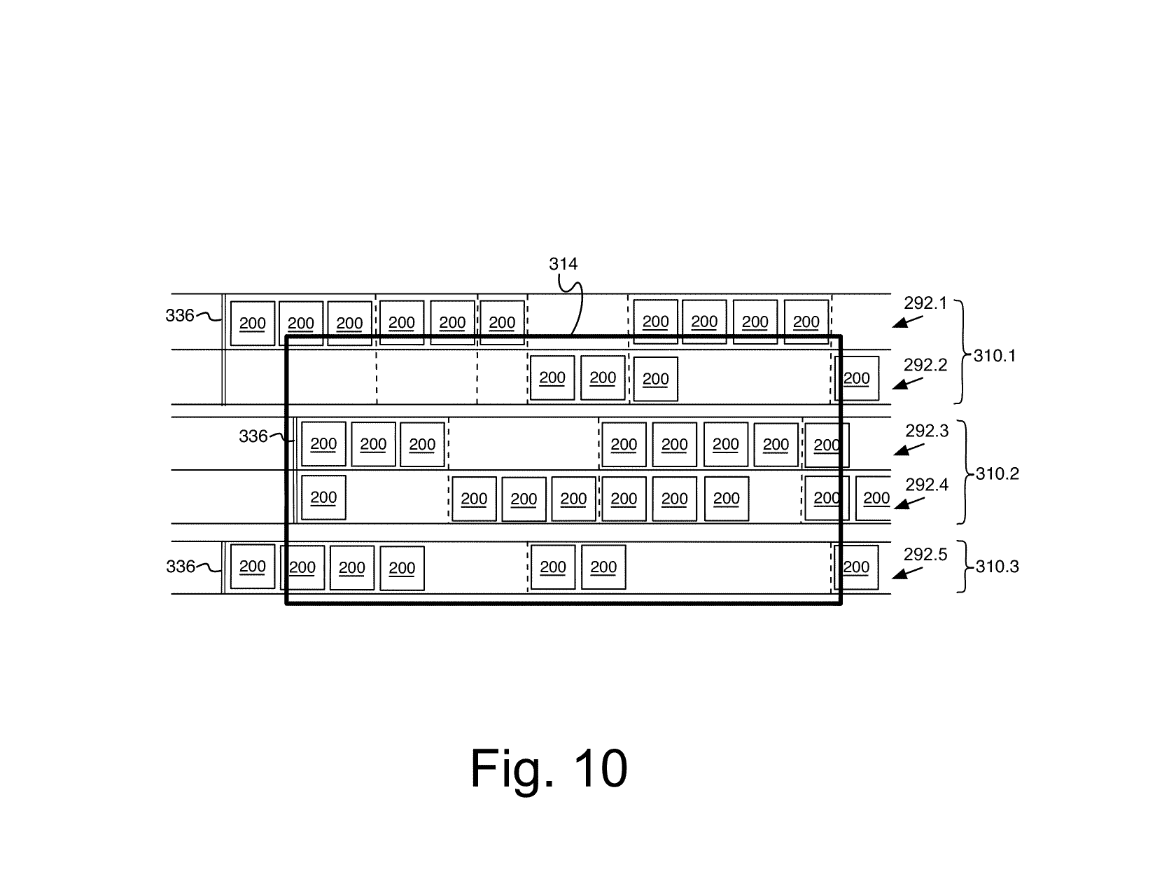

FIG. 10 shows another particular feature of the invention. While axes groups 310 may be moved independently, the display area position 314 may also be moved horizontally and vertically. The actual movement of the display area 314 may also be caused be the user or by the system.

In order to make a distinction between an axes group 310 movement and a display area 314 movement, the system may use alternative keys, a interface button for the user, or a configuration option that the user may change. Some special gestures can also be used for the mouse, trackpad, touchscreen, or body motions capture, to distinct the two different actions.

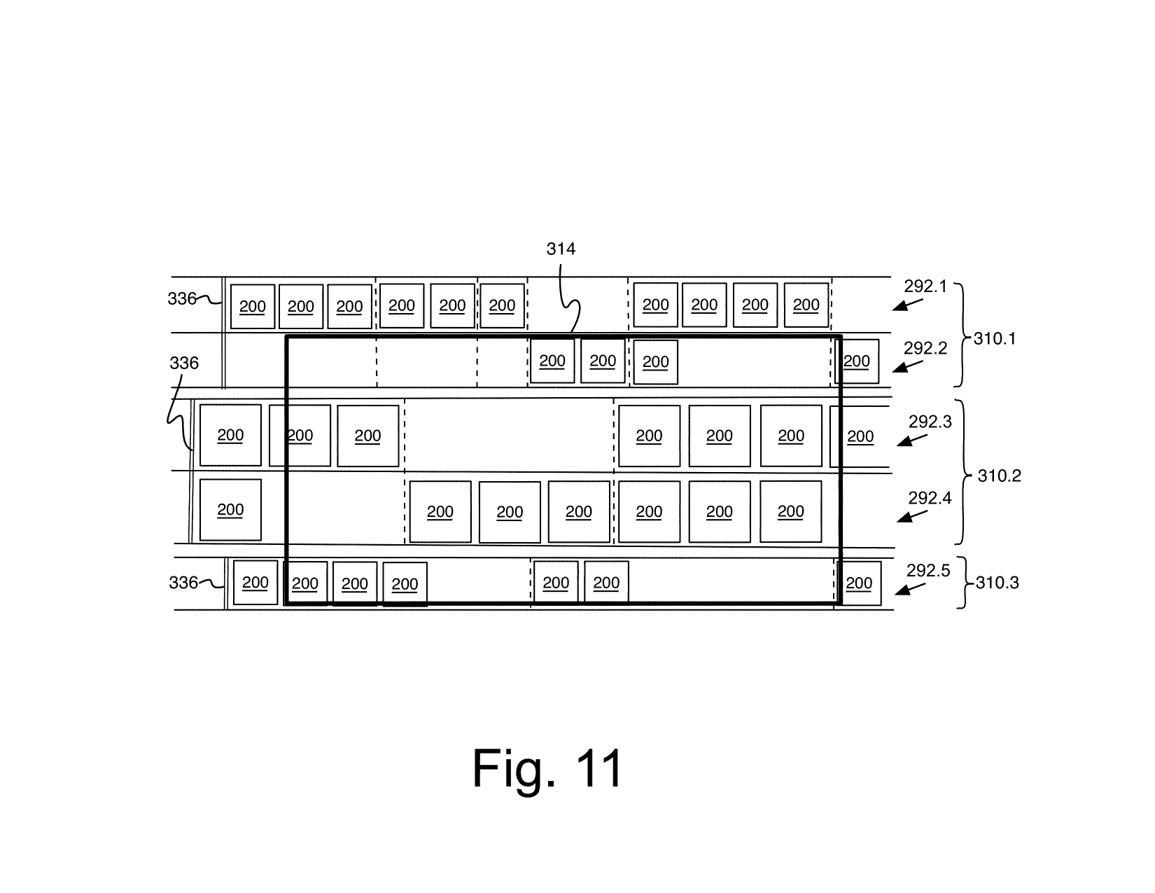

FIG. 11 depicts another particular feature of this invention. In this Figure, the user or the system magnified the axes group 310.2. By doing so, the position of the beginning of the axes 292 of the axes group 310.2, marked by the delimiter 336, may have been readjusted to keep the original documents 200 near the center of the display area 314, after the magnification. The system may have also adjusted the positions of the other axes groups 310.1 and 310.3 in order to make space for the newly increased height of the axes group 310.2.

The user may use multiple devices to communicate this magnification and reduction information, such as keyboards keys, like arrows keys, home key, end key, page up key, page down key, etc. Moreover, the user may use a computer mouse and/or trackpad and touch-screen gestures to carry out this magnification and reduction. Other devices like a remote with acceleromator-based devices, body motion sensors and voice recognition sensors may be applied.

Similarly to what is illustrated in FIG. 11, the user or the system may carry out a contraction or, stated differently, a reduction in size (not shown in the Figure) of the documents 200. The contraction would cause the documents 200 within an axes group 310 to decrease in size.

The system may also adjust the position of the axes groups 310 in the same way as when it carries out the magnification of documents 200. The system may adjust the position of documents 200 by attempting to keep the original centered documents 200 as near as possible to the center of the display area 314. This may be attained by adjusting the vertical position of other axes groups 310 in order to avoid undesired empty space between axes 292 and to keep the axes 292 compact.

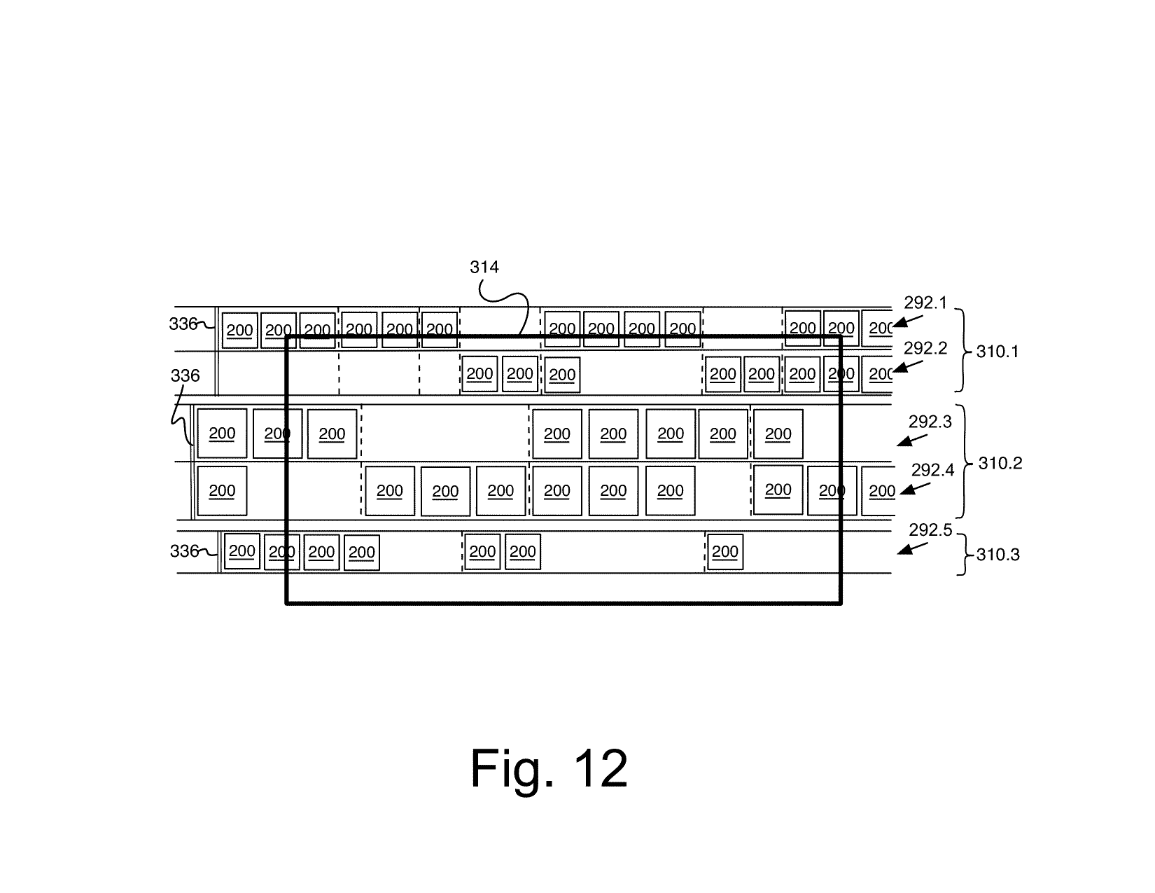

FIG. 12 depicts another feature of the present invention. In this Figure all the axes groups 310 within the display area are contracted at the same scale. After contraction, one can appreciate that a greater number of documents 200 are now visible on the display area 314. We will refer it to as “a global contraction”. Similarly to the global contraction, a global magnification (not shown in Figures) may be carried out by the user and/or the system.

In order to make a distinction between an axes group 310 magnification/reduction and a display area 314 magnification/reduction, the system may use alternative keys, an interface button for the user, or a configuration option that the user may modify as needed. Some special gestures can also be used for the mouse, trackpad, touchscreen, body motion capture, to differentiate these two actions—the global magnification from the global contraction.

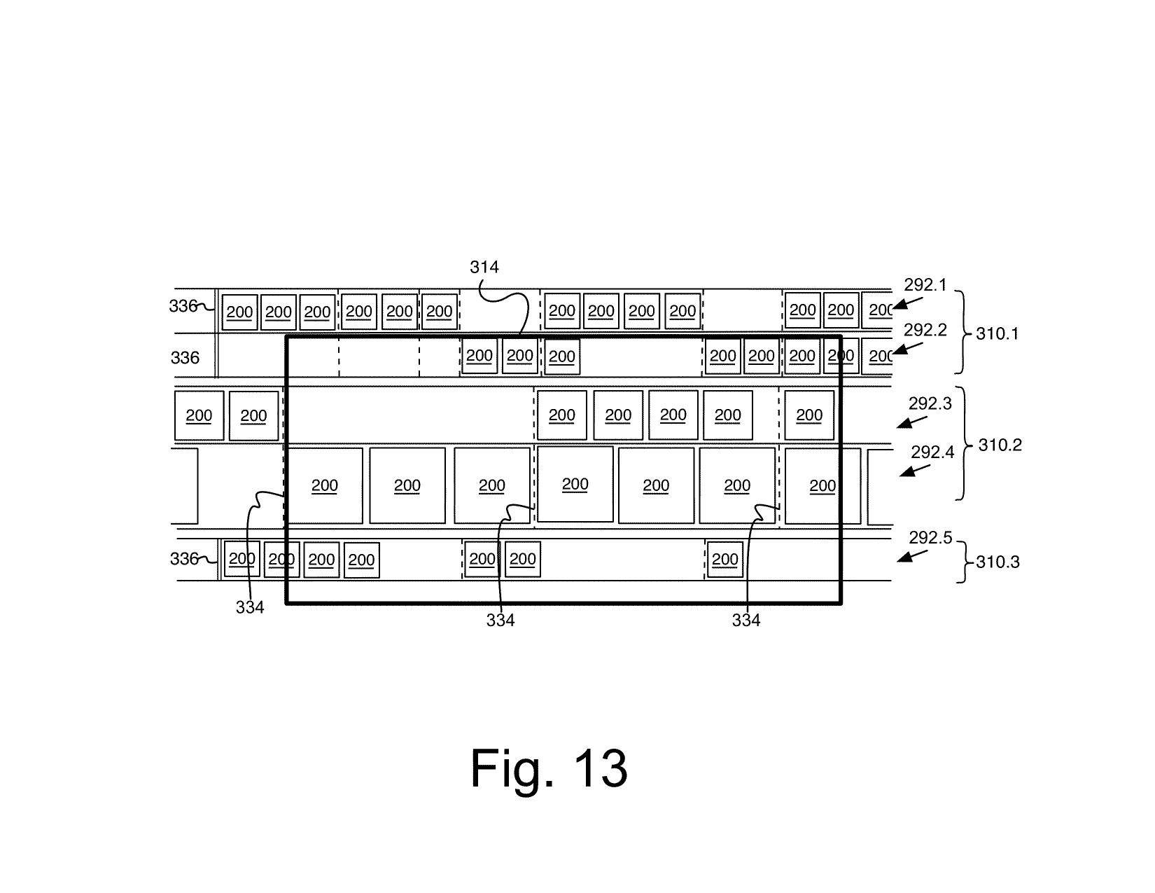

FIG. 13 depicts another feature of the present invention, where the multiple axes 292 of the same axes groups 310 are magnified and/or contracted at different ratios. This is shown in FIG. 13, where the size of the documents 200 of the axis 292.4 was magnified by 50% from its original size. The documents 200 of the axis 292.3 maintained their original size. Since the axes group 310.2 is non-linear, the size of the collation units 304 (not illustrated in the Figure) has been adjusted in order to keep the documents 200 as compact as possible while still allowing for sufficient room for them to be shown. This causes the collation unit markers 334 to be displaced accordingly after the magnification or contraction operations.

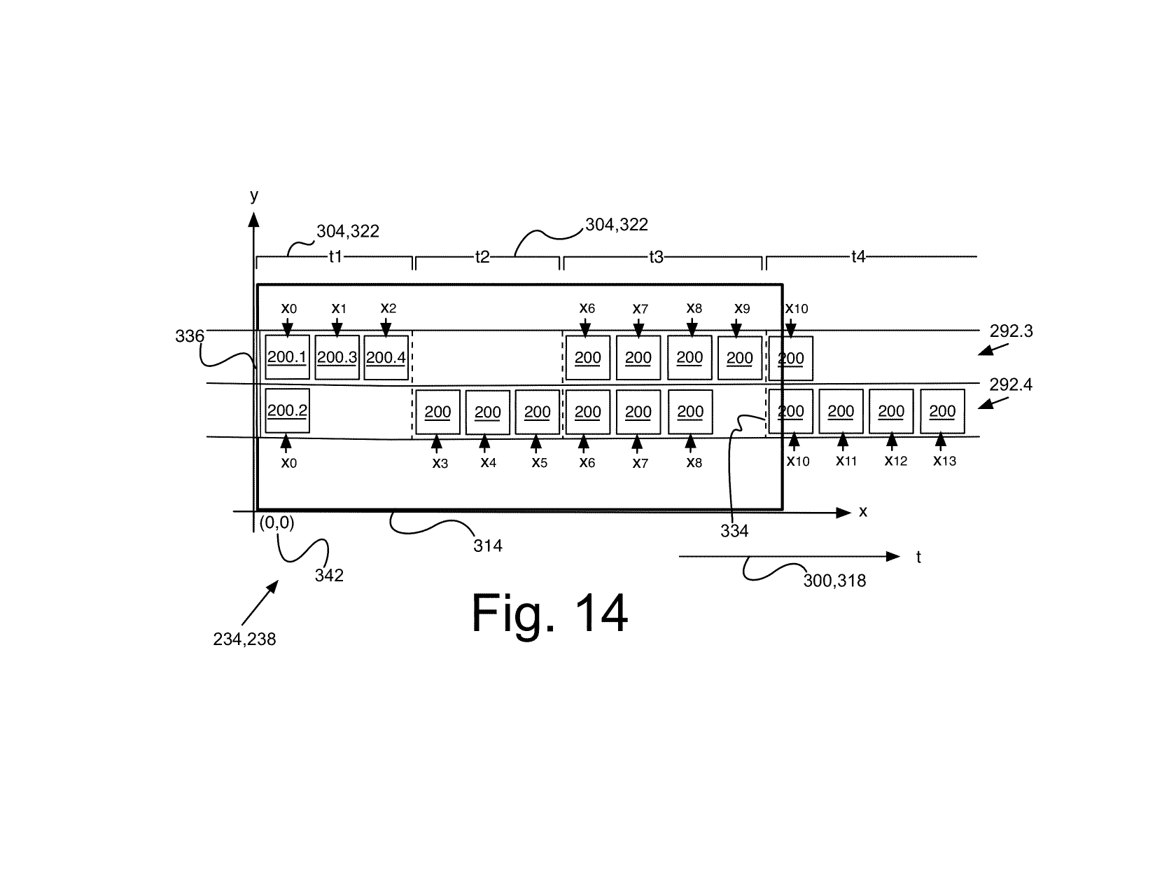

FIG. 14 illustrates two non-linear axes of documents 292 within the same axis groups 310, with non-equally spaced collation units 304. This Figure more specifically illustrates a display area 314 upon which sixteen documents 200 belonging to axes 292 may be seen. These documents 200 follow a chronological order, set up by the collation unit 304. A certain time scale 318 defines these collation units 304. Some of the axes 292 illustrated in FIG. 14 contain empty space between documents 200, in which no document 200 is displayed. Time unit t1 contains three documents 200 on the first axis 292.1 and one document 200 on the second axis 292.2. Time unit t2 contains no documents 200 on the first axis 292.1 and three documents 200 on the second axis 292.2. Time unit t3 contains four documents 200 on the first axis 292.1 and three documents 200 on the second axis 292.2. Time unit t4 is not shown completely in the figure and contains at least one document 200 on the first axis 292.1 and at least four documents 200 on the axis 292.2. The first documents 200 of the time unit t4 are partially visible in the display area 314, while the other documents 200 of time unit t4 are not visible to the user through the display area 314.

The first document 200 of the axis 292 presented in FIG. 14 is also the first displayed on the display area 314, located at the most left side of the display area 314. This is because the position of the beginning of the axes 292 coincides with the frame of the display area 314.

Furthermore, FIG. 14 provides the coordinates of the documents 200 listed on the axis 292. The position of each of the documents 200 displayed on the display area 314 is identified in relation to the display area 314, and more specifically—in relation to its left side. The intersection of the left and of the lower sides of the display area 314 is identified by the (0,0) mark 342, where 0,0 stand for the x and respectively y coordinates illustrated herein. This is the preferred position of the origin point of the display area. Nevertheless, the respective (0,0) mark 342 position may be placed somewhere else, depending on the used programming languages or the graphical layer frameworks convention.

The positions of documents 200 presented on the display area 314 are identified by the xᵢ marks respectively. For example, documents 200.1 and 200.2 are marked by the position x₀. Document 200.3 is marked by position x₁. Document 200.4 is marked by position x₂ and so on. The position of these documents 200 and of any of the documents 200 on the axis 292 or any other axes of documents is defined by the following equation:

f(x)=x Equation 1

In Equation 1, x is the position (i.e. distance often expressed in pixels) of the any given document in respect to the beginning of the display area 314.

If the size of each of the documents 200 and their margins presented in FIG. 14 were to be 200 pixels, for example, the actual coordinate of document 200.1 would be 0 pixels, of 200.2 would be 200 pixels, of 200.3 would be 400 pixels, and so on.

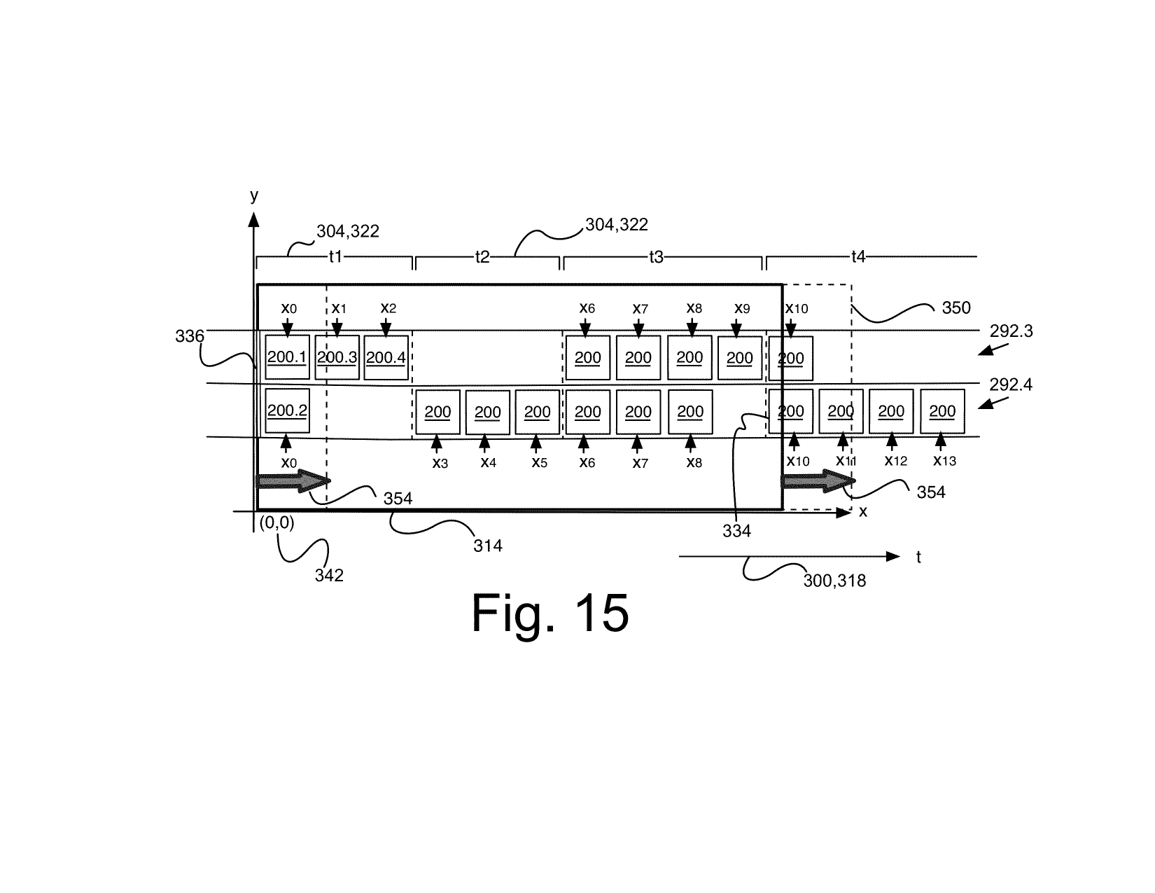

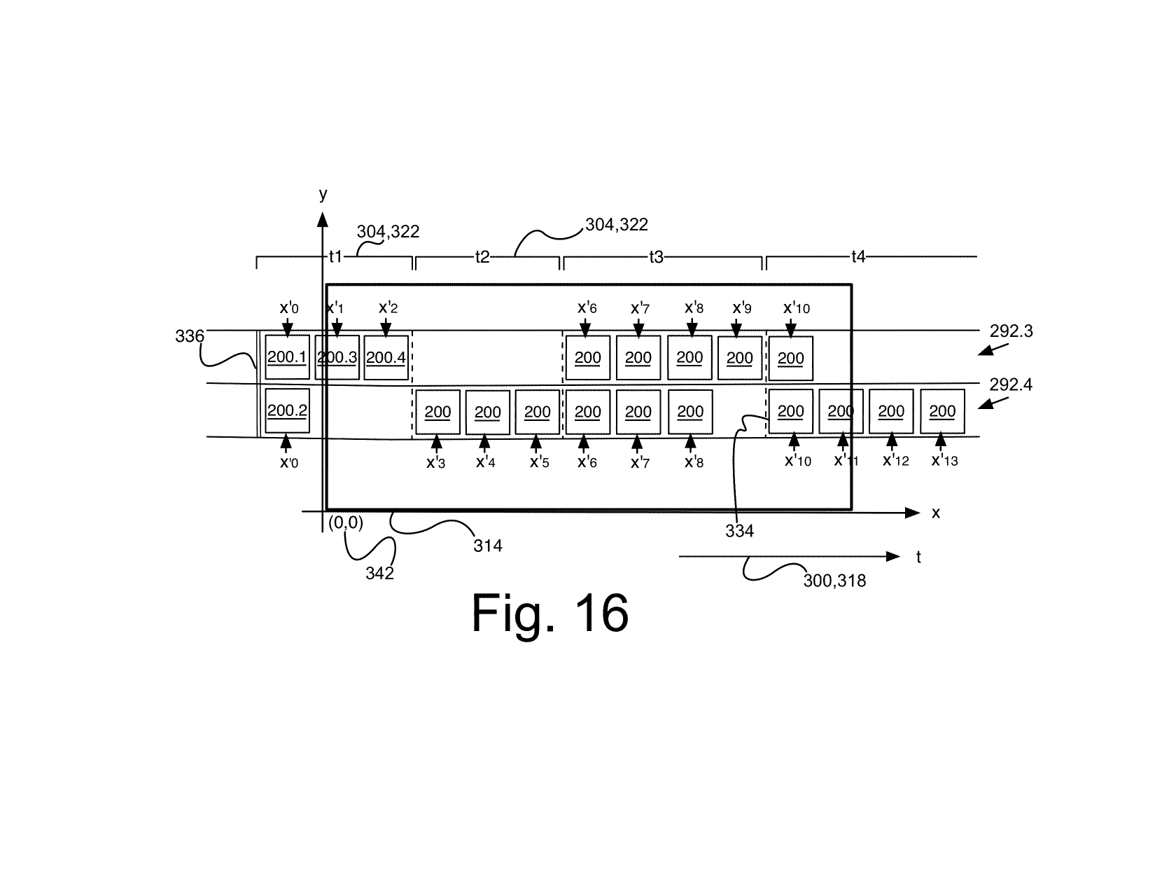

FIGS. 15-16 illustrate how the movement of the display area 314 affects the position of the documents 200 in respect to the display area 314. The purpose of the FIGS. 15-16 is to illustrate how the use of the method in Equation 1 listed above causes the update of the position of documents 200 in situations where the display area 314 is subject to movement. FIG. 15 illustrates the movement of the display 314 to the right, as indicated by the arrow 354.

The movement of the display area 314, however, does not limit to the right direction only. For example, it may also move upwards, downwards, diagonally, on a trajectory defined by a linear or a parabolic function or a combination thereof, in a regular or non-regular form, or in any desired and possible manner and direction. The depiction of the movement of the display area 314 to the right is only for illustrative purposes and does not seek to delineate the purpose of the respective invention.

In FIG. 15, the arrows 354 illustrate a vector that represents the movement of the display area 314. The direction of the movement is to the right and its magnitude is greater than the width of a document 200 illustrated herein. The displacement of the display area line 350 shows the new coordinates of the display area 314 once subject to movement leftwards.

For the purpose of simplifying the explanation provided herein, we will consider the movement of the display area 314 as equivalent to the movement of the individual axes group 310, by enforcing the displacement of every axes group all at once.

FIG. 16 illustrates the outcome of the movement of the display area 314 to the right. As a result of the movement, the documents 200.1 and 200.2 of the time unit t₁ are now not visible to the user; document 200.3 is now partially visible to the user. Moreover, one more document from the time unit t4 is now visible to the user. As a result of the movement, the position of each document 200 has been updated from x₀, x₁, x₂, . . . to x′₀, x′₁, x′₂, and so on. If the movement of the display area 314 were to be 250 pixels to the right and the size of the documents 200 were of 200 pixels, x′₀ would be at 250 pixels, x′₁ would be at −50 pixels, x′₂ would be at 150 pixels, and so on.

In a static positioning system, where the user is unable to navigate content by moving axes groups 310 and/or the position of the display area 314, the method presented in Equation 1 may be an efficient one. However, when navigation is common and may be animated, this method necessitates a constant update of the position of the documents on axes 292. If the axes 292 have a significant number of documents 200, this method could cause the system to have a high Computer Processing Unit (CPU) usage. Moreover, the system may become slow overtime as a result of the need to constantly update the position of each of the documents 200 on the axes 292.

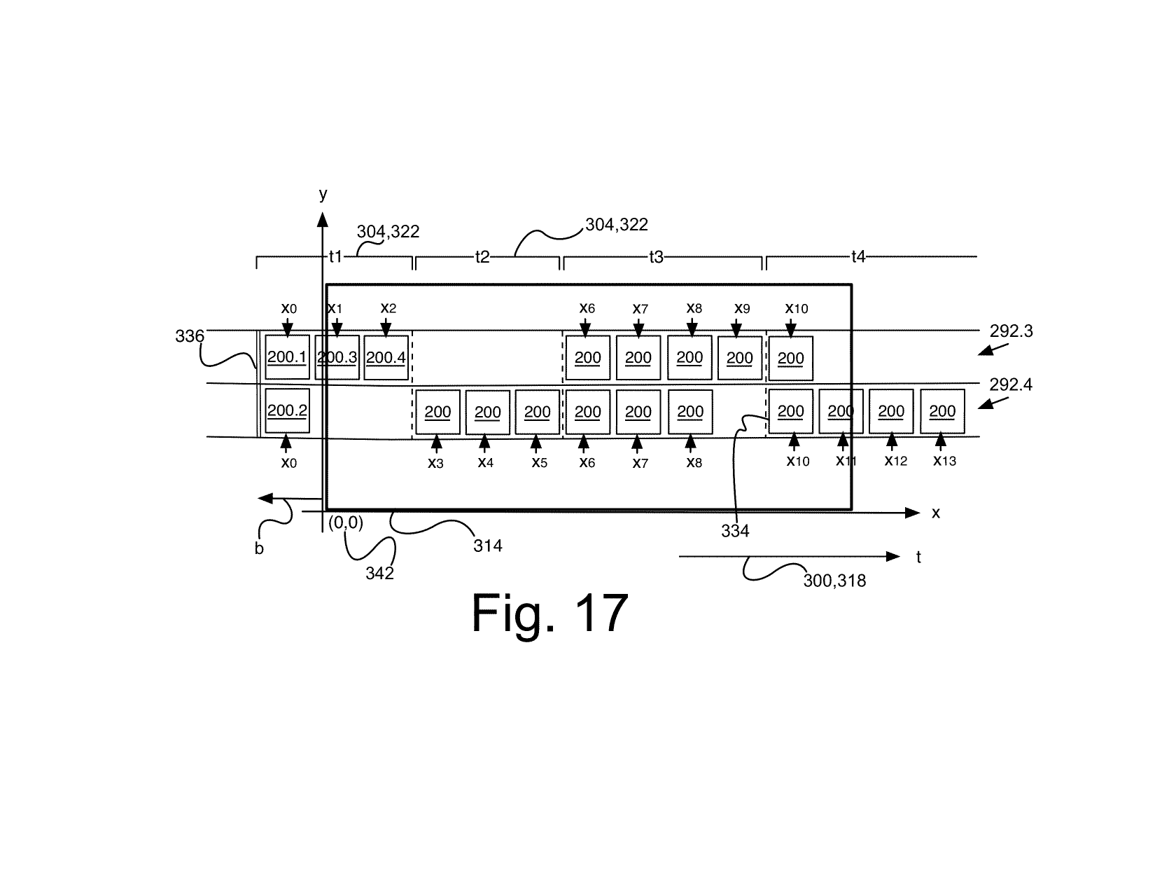

An alternate embodiment would be to consider the position of documents 200 as not relative to the position on the display area 314. This is to prevent the need for updating all the positions of documents 200 when a movement of the display area 314 occurs. This phenomenon is illustrated in FIG. 17, where the position of x₀, x₁, x₂, . . . is the same as their original position shown in FIG. 14.

In FIG. 17, the position of x₀, x₁, x₂, . . . is relative to the beginning of the axes groups 310, marked by the delimeter 336. The axes groups 310 are now responsible to store their relative position to the display area 314. This relative position is embodied as the variable b, shown in FIG. 17. By doing so, the computer system would only need to update the variable b of the axes groups 310, when navigation occurs. The navigation may be carried out by moving either an axis group 310 and/or the display area 314.

Notably, FIG. 17 also illustrates the outcome of the displacement shown in FIG. 15. Following the same example described in FIG. 16, as a result of the displacement, the variable b would now be −250 pixels, while x₀—0 pixel; x₁, would be 200 pixels, while x₂—400 pixels, and so on.

To determinate the position of an element on the display area 314, we would use the following function:

f(x)=x+b Equation 2

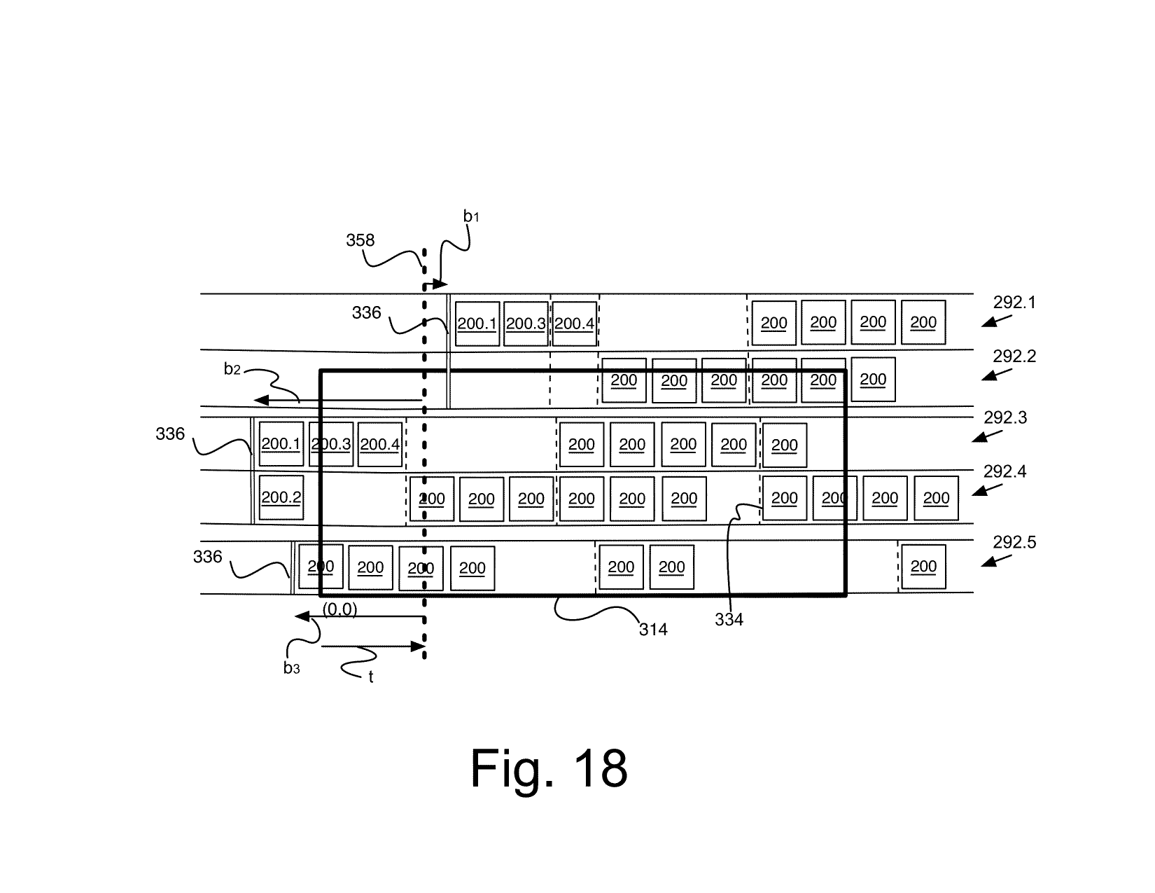

When dealing with multiple axes groups 310, each axes group 310 must have its own b. When navigating, the user and/or the system may only move one axes group 310 at a time or the whole display area 314. When using Equation 2, the movement of the display area 314 would cause each value b (b1, b2, b3, as seen in FIG. 18) of each axes group 310 to be updated. If there is a large number of axes groups 310, the actual update may be carried out in a slow manner.

One alternate embodiment, illustrated in FIG. 18, would be to add a variable t. This variable t that would be a reference position relative to a reference line 358, invisible to the user. The length of the variable t would reflect the distance between the reference line 358 and the beginning of the display area 314 (its left side). If an axes group 310 movement is carried out, the respective movement would imply the immediate update of the b value of the axes group 310. Similarly, if the display area 314 is moved, the movement would imply the immediate update of its t. To determinate the final position of an element on the display area 314, we would use the following function:

f(x)=x+b+t Equation 3

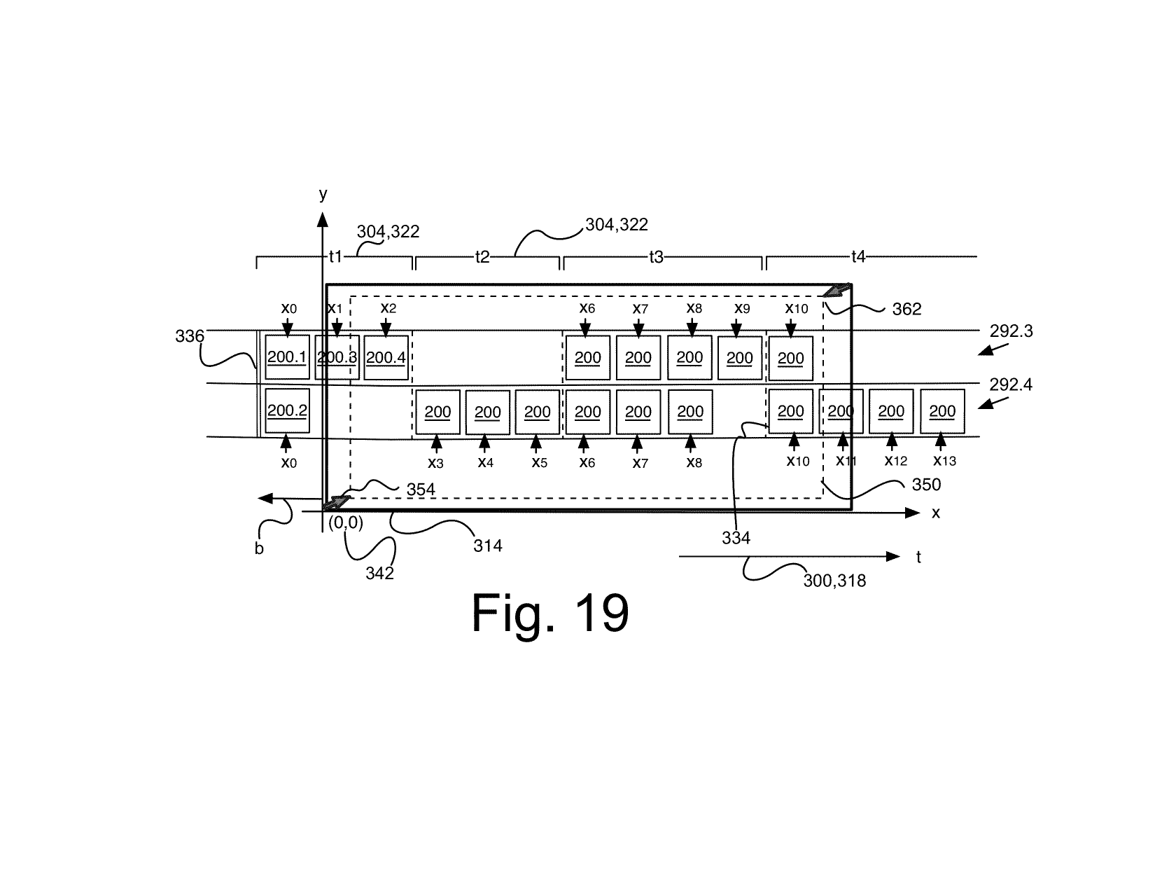

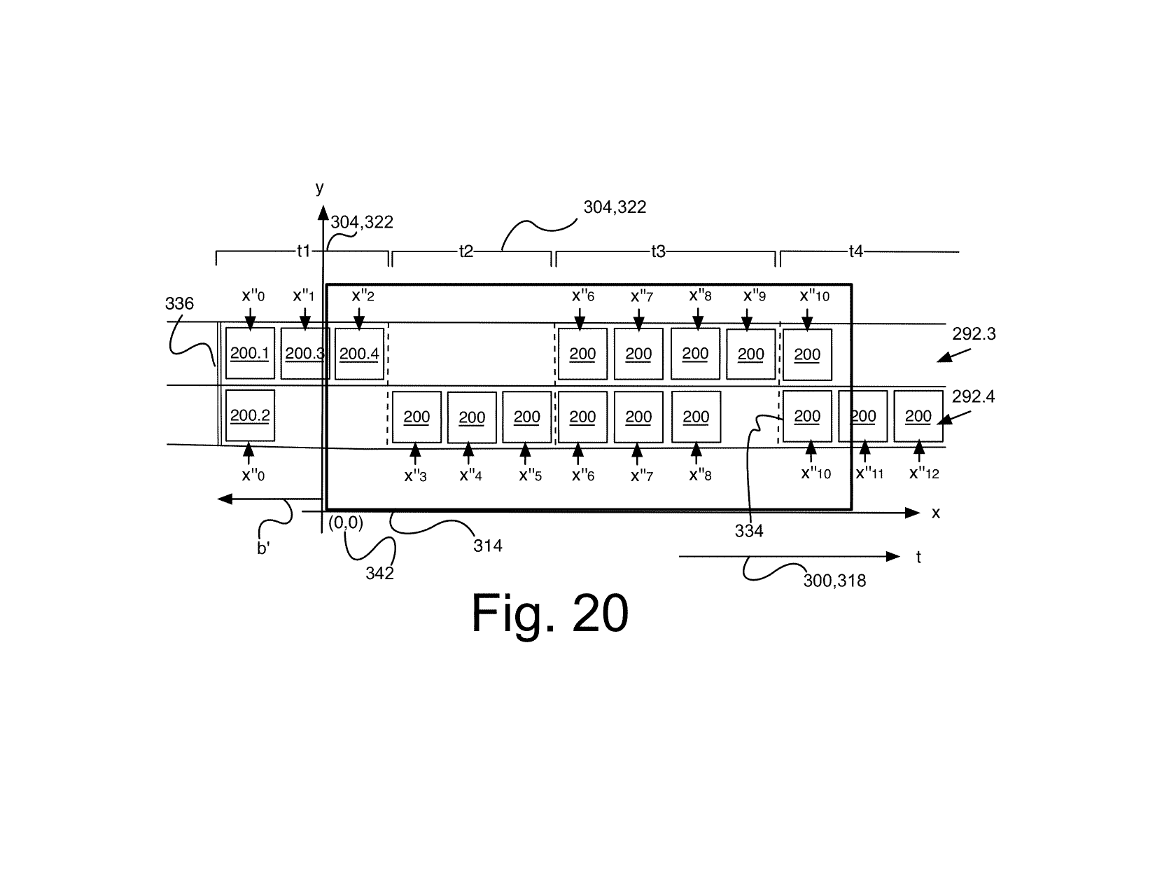

FIGS. 19 and 20 illustrate the magnification of the axes 292. FIG. 19 shows the contraction 362 of the display area 314 desired by the user or system in order to magnify the documents 200 within the display area 314. The arrow 354 shows the direction of the contraction 362.

FIG. 20 illustrates the result of the magnification of the documents 200. While the dimensions of the display area 314 remained unchanged, the size of the documents has been magnified as the result of this operation. If we use the element position formulas described in Equations 1-3, we would need to update each position x₀, x₁, x₂, . . . to the new values x″₀, x″₁, x″₂, and so on. Similarly, the axis position b would be updated to b′. The update would be caused by the effect of the magnification. Since, the width of each document 200 was increased, the width of each collation unit 304 has been increased as well. As a result, the position of each document 200 changed.

Similar to the displacement of the display area 314 illustrated in FIGS. 14-16, this magnification would cause the system to update the positions of the documents 200 and of the axes 292 within the axes environment. If the user has a great number of documents 200, the update of the position of each document 200 may be a CPU-costly operation. Moreover, it may be carried out relatively slow. Moreover, the update may be even worse if the magnification is applied frequently to simulate some kind of animation.

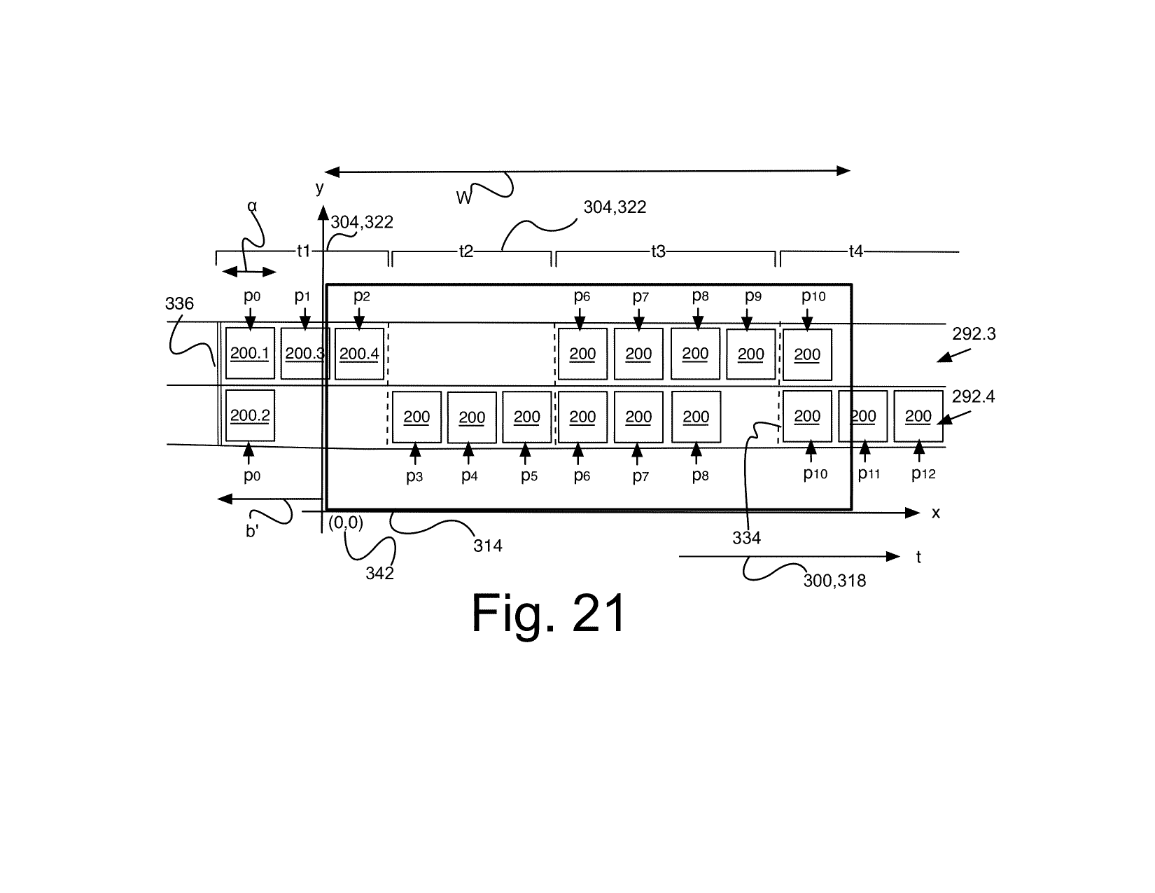

FIG. 21 illustrates a solution to this problem. This solution allows one to attain a better magnification and contraction of the axes groups 310 or of the display area 314. For that, we introduce the variable α as the width of a document 200. Instead of using the position information x₀, x₁, x₂, . . . on documents 200, we are now using a document-width based positional system. In FIG. 21, x₀, x₁, x₂ . . . illustrated in FIG. 15, are replaced by p₀, p₁, p₂ . . . . In FIG. 15, p₀, p₁, p₂, . . . are used to express the document-width a position of the documents 200. In this example, p₀ would be 0, p₁ would be 1, p₂ would be 2 and so on. To determine the position of a document 200 we would, consequently, use the following formula:

f(p)=∝p+b Equation 4

When adjusting the magnification factor or width of documents α, the b variable would need to be adjusted according to the variation of the magnification factor α.

Let a be the magnification factor and b—the position of the axes group 310. Moreover, let W be the width of the display area 314 in pixels and let α′ (not shown in the Figure) be the new magnification factor caused by the magnification or contraction caused by the user. For that, we would need to define the new position b′ of the axes group 310. If we would like to use the center of the display area 314 as a line of reference, then we could use the following equation to calculate the new position b′:

$${Δ}_{α} = \frac{{α}^{′}}{α} \\ {b}^{′} = {Δ}_{α} \cdot b - \frac{( {Δ}_{α} - 1 ) \cdot W}{2} \qquad Equation 5$$

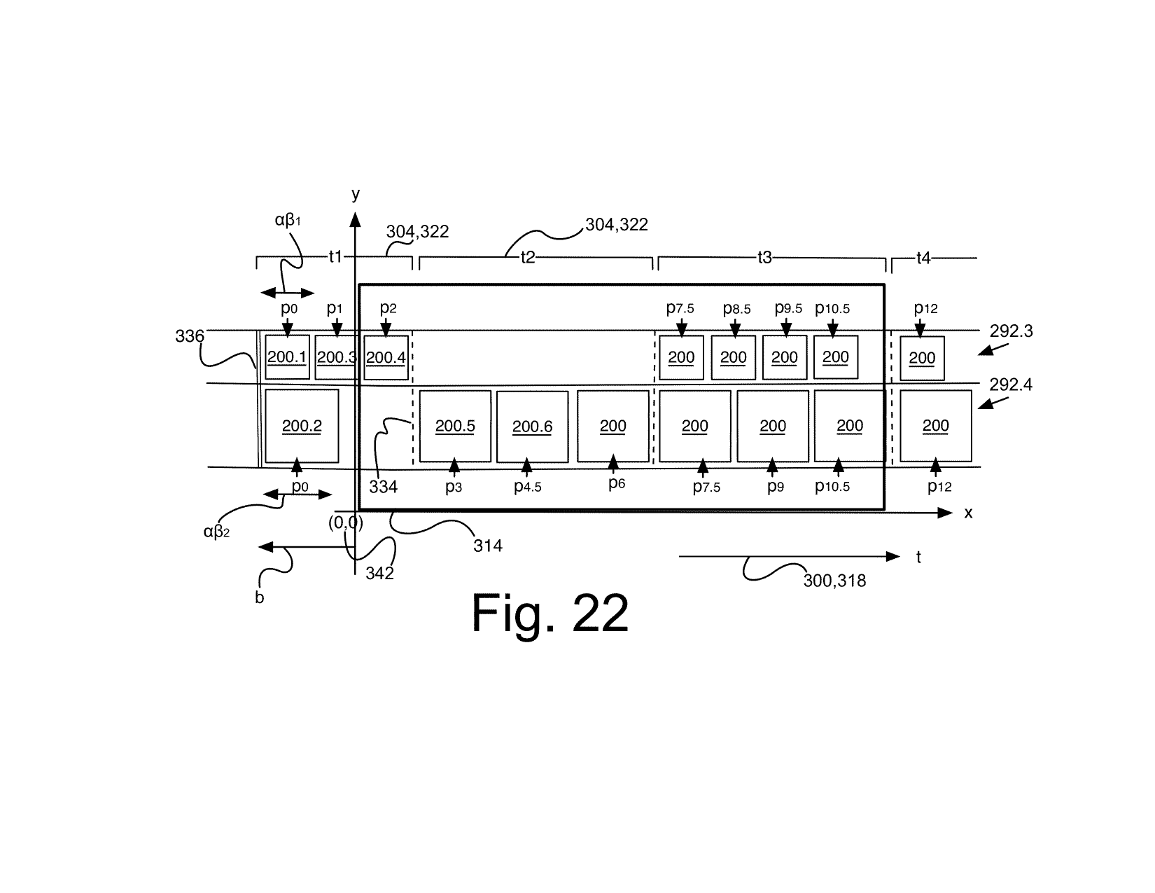

A second magnification factor may be applied independently on each axis 292 of an axes group 310. Such a case is illustrated in FIG. 22. One can appreciate how the sizes of the collation units 304 have been nicely adjusted in order for them to reflect the sum of the widths of the documents 200 within each collation unit 304. This is done in order to provide the minimum space necessary to fit the larger sized documents 200 on the axis 292.2. Comparatively to FIGS. 14-17, in FIG. 22, the collation units t2 and t3 are wider, in order to allow for more space for the larger documents 200 of the axis 292.4. Notably, the collation unit t1 maintained its original size because the totality the widths of the three documents 200.1, 200.3, 200.4 within it, are still larger than the width of the document 200.2.

Furthermore, FIG. 22 introduces two new variables: β₁ and β₂. These are relative magnification factors between axes groups 310. While many configurations are possible for the same ratio between α, β₁ and β₂ for the same result, we tend to keep β₁ and β₂ as near as possible to 1. In this example, β₁ could be 1 and β₂ could be 1.5. This would cause documents 200 from the axis 292.2 to be 50% larger than the documents 200 from the axis 292.1. In this case, a would be the width of the document 200 of axis 292.1. Let a be 200 pixels. The width of the documents 200 of the axis 292.2 would, consequently, equal to αβ₂, or, to 300 pixels.

When calculating the sizes of the collation units 304, the system needs to take in consideration the relative magnification factors β₁ and β₂. In FIG. 22, one can appreciate that the different positions p₀, p₁, p₂, p₃, p_{4.5}, p₆, p_{7.5}, p_{8.5}, p₉, p_{9.6}, p_{10.6} and p₁₂, have the corresponding values: 0, 1, 2, 3, 4.5, 6, 7.5, 8.5, 9, 9.5, 10.5, and 12 respectively. The variables have been labeled in this manner to facilitate the understanding of the concepts described herein. All these positions are at the leftmost possible location in respect to the beginning of a collation unit 304 and to the widths of the previous documents within the collation unit 304.

To calculate the position of the document 200 over an axis 292, the system may use the formula described in Equation 3.

The position for each document 200 may alternatively be expressed by the width of the documents 200 of the axis 292. Let axis A (not shown in the Figure) have documents with widths equal to αβ_{A}. In that case, in FIG. 22, document 200.5 would have the position p2=2, while 200.6 would have the position p3=3 and so on. Then, to calculate the position of a document 200 in each axis A, the system may use the following formula:

f_{A}(p)=∝β_{A}p+b Equation 5

Similarly, as explained in FIG. 18 where a reference position t was introduced and where the b variable from each axis 292 was defined as relative to the reference position t, we could use a reference magnification factor λ (not shown in Figures) that could be the reference magnification factor for altering the axes groups 310 all at once. This occurs when a global magnification factor change takes place. Each axis group 310 variable a may be updated individually when only the axes group 310 magnification is modified. In such a case, the function used to calculate the position of a document 200 on the display area 314 would be:

f(p)=λ∝p+b+t Equation 6

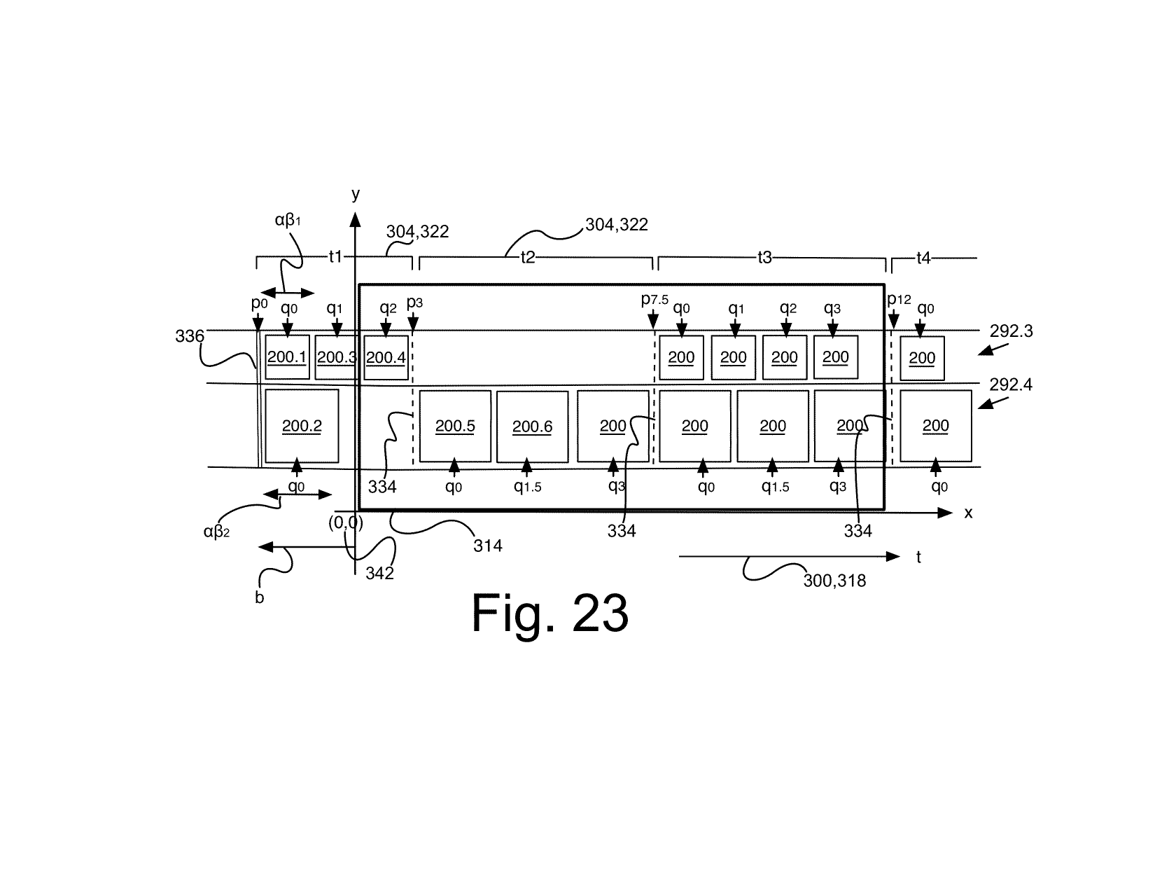

One alternate embodiment is shown in FIG. 23. When the system may be dealing with frequent independent axes 292 magnification and/or reduction within an axes group 310, or with frequent insertion and/or removal of documents 200, the system could benefit from adding a supplement variable associated to collation units 304. This is illustrated in FIG. 23 where collation unit t1 has the position information p₀=0; the collation unit t2—the position information p₃=3; the collation unit t3—the position information p_{7.5}=7.5; and the collation unit t4—the position information p₁₂=12. The documents 200 in axes 292 now contain a position information that is relative to the beginning of the collation unit 304, marked by the beginning of the axis marker 336 or a collation unit marker 304. In FIG. 23, the document 200 position information variables q₀, q₁, q_{1.5}, q₂ and q₃ would have the respective values 0, 1, 1.5, 2 and 3. To compute the final position of a document 200, FIG. 23 would use the following formula:

f(p,q)=(p+q)+b Equation 7

When carrying out an operation that may alter the position information of multiple documents 200 (i.e.: the insertion of documents 200, the removal of documents 200 and the magnification of an axis 292 within a group 310), this method may greatly reduce the number of variables needed to be updated. Moreover, this method may be applicable when the system may need to update the position collation units 304 and of the documents 200, when the ratio of which may be defined in the following manner:

$$\frac{\# of collation units 304}{\# of documents 200} ∈ [ 0 , 1 ] \qquad Equation 8$$

These above equations may be altered to include multiple techniques presented here at once, or adding custom personalization.

The description and the drawings that are presented above are meant to be illustrative of the present invention. They are not meant to be limiting of the scope of the present invention. Modifications to the embodiments described may be made without departing from the present invention, the scope of which is defined by the following claims:

What is claimed is:

1. A method of positioning elements on a display along a plurality of ordering functions, the method comprising:
displaying a first plurality of elements in a generally rectilinear arrangement on a basis of a first collation function;
displaying a second plurality of elements in a generally rectilinear arrangement on a basis of a second collation function;
performing an action requiring a modification of the positions of the elements on the display, the modification of the respective positions of the elements on the display being represented by at least one of a first distance between an original display position and a first reference position associated with the first plurality of elements and a second distance between the original display position and a second reference position associated with the second plurality of elements; and
updating the respective positions of the displayed elements on a basis of at least one of the first distance and the second distance, whereby the updated respective positions are determined without individually recalculating the respective positions of the elements.

2. The method of claim 1, wherein at least one of the collation functions is a linear chronological ordering.

3. The method of claim 1, wherein at least one of the collation functions is a non-linear chronological ordering.

4. The method of claim 1, wherein at least some of the elements are documents.

5. The method of claim 1, further comprising:
resizing the first plurality of elements independently from the second plurality of elements; and
updating the respective positions of the displayed elements on a basis of at least one of the first distance and the second distance.

6. The method of claim 5, further comprising a resizing coefficient associated with the resizing of the first plurality of elements independently from the second plurality of elements, wherein updating the respective positions of the displayed elements is at least partially made on the basis of the resizing coefficient.

7. The method of claim 1, wherein elements along at least one of the generally rectilinear arrangements are distributed in accordance with a plurality of collation units and at least one collation unit is associated with at least one of the reference positions.

8. The method of claim 7, wherein elements are adapted to be unevenly distributed in accordance with collation units along the generally rectilinear arrangement.

9. The method of claim 1, wherein the action is a pan.

10. The method of claim 1, wherein the action is a displacement of the elements displayed along the generally rectilinear arrangement thereof.

11. The method of claim 1, wherein the action is a magnification of the displayed elements.

12. A non-transitory computer-readable medium having stored thereon computer-readable instructions that, when executed by a computer, cause the computer to perform operations for managing display locations of elements on a display along a plurality of ordering functions, the operations comprising:
displaying a first plurality of elements in a generally rectilinear arrangement on a basis of a first collation function;
displaying a second plurality of elements in a generally rectilinear arrangement on a basis of a second collation function;
performing an action requiring a modification of the positions of the elements on the display, the modification of the respective positions of the elements on the display being represented by at least one of a first distance between an original display position and a first reference position associated with the first plurality of elements and a second distance between an original display position and a second reference position associated with the second plurality of elements; and
updating the respective positions of the displayed elements on a basis of at least one of the first distance and the second distance, whereby the updated respective positions are determined without individually recalculating the respective positions of the elements.

13. The non-transitory computer-readable medium of claim 12, wherein at least some of the elements are documents and wherein at least one of the collation functions is a linear chronological ordering.

14. The non-transitory computer-readable medium of claim 12, wherein at least some of the elements are documents and wherein at least one of the collation functions is a non-linear chronological ordering.

15. The non-transitory computer-readable medium of claim 12, further comprising:
resizing the first plurality of elements independently from the second plurality of elements; and
updating the respective positions of the displayed elements on a basis of at least one of the first distance and the second distance.

16. The non-transitory computer-readable medium of claim 15, further comprising a resizing coefficient associated with the resizing of the first plurality of elements independently from the second plurality of elements, wherein updating the respective positions of the displayed elements is at least partially made on the basis of the resizing coefficient.

17. The non-transitory computer-readable medium of claim 12, wherein elements along at least one of the generally rectilinear arrangements are distributed in accordance with a plurality of collation units and at least one collation unit is associated with at least one of the reference positions.

18. A device, comprising a processor configured to present a graphical user interface for displaying graphical elements in relation with the representations of objects, the graphical interface comprising areas adapted to provide the operations comprising:
displaying a first plurality of elements in a generally rectilinear arrangement on a basis of a first collation function;
displaying a second plurality of elements in a generally rectilinear arrangement on a basis of a second collation function;
performing an action requiring a modification of the positions of the elements on the display, the modification of the respective positions of the elements on the display being represented by at least one of a first distance between an original display position and a first reference position associated with the first plurality of elements and a second distance between an original display position and a second reference position associated with the second plurality of elements; and
updating the respective positions of the displayed elements on a basis of at least one of the first distance and the second distance, whereby the updated respective positions are determined without individually recalculating the respective positions of the elements.

19. The device of claim 18, further comprising:
resizing the first plurality of elements independently from the second plurality of elements; and
updating the respective positions of the displayed elements on a basis of at least one of the first distance and the second distance.

20. The device of claim 18, further comprising a resizing coefficient associated with the resizing of the first plurality of elements independently from the second plurality of elements, wherein updating the respective positions of the displayed elements is at least partially made on the basis of the resizing coefficient.
